(19) United States
(12) Patent Application Publication
(10) Pub. No.: US 2014/0062171 A1
(43) Pub. Date: Mar. 6, 2014

(54) NON-PNEUMATIC TIRE

(71) Applicants: Kevin L. Martin, Washburn, IL (US); Maria C. Herrera De Kontz, Chillicothe, IL (US)

(72) Inventors: Kevin L. Martin, Washburn, IL (US); Maria C. Herrera De Kontz, Chillicothe, IL (US)

(73) Assignee: Caterpillar Inc.

(21) Appl. No.: 13/599,628

(22) Filed: Aug. 30, 2012

(51) Int. Cl. B60C 7/00; B60B 3/00

(52) U.S. Cl. 301/62; 152/310

(57) ABSTRACT

A non-pneumatic tire includes an inner circumferential barrier configured to be coupled to a hub, an outer circumferential barrier radially spaced from the inner circumferential barrier, and a support structure coupling the inner circumferential barrier to the outer circumferential barrier. The support structure at least partially defines a first axial side of the tire and a second axial side of the tire opposite the first axial side of the tire. The support structure includes a plurality of first ribs and a plurality of second ribs extending between the inner circumferential barrier and the outer circumferential barrier. At least some of the plurality of first ribs extend from the first axial side of the tire toward the second axial side of the tire, such that the at least some first ribs terminate prior to reaching the second axial side of the tire.

### TECHNICAL FIELD

The present disclosure relates to non-pneumatic tires, and more particularly, to non-pneumatic tires for machines.

### BACKGROUND

Machines such as vehicles, either self-propelled or pushed or pulled, often include wheels for facilitating travel across terrain. Such wheels often include a tire to protect a rim or hub of the wheel, provide cushioning for improved comfort or protection of passengers or cargo, and provide enhanced traction via a tread of the tire. Pneumatic tires are an example of such tires. Pneumatic tires include an enclosed cavity for retaining pressurized air, with the enclosed cavity being formed by either a separate annular tube or by a sealed coupling between the tire and a rim of the hub. By virtue of the pressurized air, the tire provides cushioning and shock absorption as the wheel rolls across terrain.

Pneumatic tires, however, may suffer from a number of possible drawbacks. For example, pneumatic tires may deflate due to punctures or air leaks, rendering them unsuitable for use until they are repaired or replaced. In addition, pneumatic tires may be relatively complex due to separate tubes or complex configurations for providing a sealed coupling between the tire and the rim.

In addition to these drawbacks, pneumatic tires may suffer from a number of economic drawbacks. For example, due to the relatively complex nature of pneumatic tires, manufacturing facilities for pneumatic tires may be prohibitively costly, requiring a large capital investment. Moreover, pneumatic tires formed from natural rubber may be susceptible to dramatic variability in production costs due to inconsistent availability of natural rubber.

Non-pneumatic tires, such as solid tires or tires not retaining pressurized air, may provide an alternative to pneumatic tires. Non-pneumatic tires may be relatively less complex than pneumatic tires because they do not retain air under pressure. However, non-pneumatic tires may suffer from a number of possible drawbacks. For example, non-pneumatic tires may be relatively heavy, and may not have a sufficient ability to provide a desired level of cushioning. For example, some non-pneumatic tires may provide little, if any, cushioning, potentially resulting in discomfort to passengers and/or damage to cargo. In addition, some non-pneumatic tires may not be able to maintain a desired level of cushioning when the load changes on the tire. In particular, if the structure of the non-pneumatic tire provides the desired level of cushioning for a given load, it may not be able to continue to provide the desired level of cushioning if the load is changed. For example, if the load is increased, the structure of the non-pneumatic tire may collapse, resulting in a loss of the desired level of cushioning or potentially damaging the tire. If the load is decreased, the level of cushioning may also decrease, resulting in an undesirable reduction in comfort and/or protection. In addition, conventional non-pneumatic tires that provide adequate cushioning may not be able to maintain the desired machine height when loaded, due to collapse of the tire under load.

An example of a cushioned tire that is not inflated is disclosed in U.S. Pat. No. 2,620,844 to Lord (“the '844 patent”). In particular, the '844 patent discloses a cushioned tire formed from a resilient material such as rubber. The tire includes a rigid inner rim shaped to be mounted on a wheel, an outer continuous tread section formed of resilient material such as rubber, and a cushion formed of resilient material extending between and connected to or united with the rim and tread section. The cushion of the tire is provided by openings that extend from one side to the other of the tire and are formed by walls which extend around the tire, with the walls being formed to transmit loads that act radially between the rim and tread.

Although the cushioned tire disclosed in the '844 patent provides an alternative to pneumatic tires, it may suffer from a number of drawbacks associated with non-pneumatic tires. For example, the tire disclosed in the '844 patent may not be able to maintain a desired level of cushioning when the load on the tire changes.

The non-pneumatic tire disclosed herein may be directed to mitigating or overcoming one or more of the possible drawbacks set forth above.

### SUMMARY

In one aspect, the present disclosure is directed to a non-pneumatic tire. The tire includes an inner circumferential barrier configured to be coupled to a hub, an outer circumferential barrier radially spaced from the inner circumferential barrier, and a support structure extending between the inner circumferential barrier and the outer circumferential barrier and coupling the inner circumferential barrier to the outer circumferential barrier. The support structure includes a plurality of first ribs extending between the inner circumferential barrier and the outer circumferential barrier, wherein the first ribs have a cross-section substantially perpendicular to an axial direction of the tire, with the cross-section having a first curvilinear shape. The first curvilinear shape is a curve having either a single direction of curvature or a direction of curvature that changes once as the first ribs extend between the inner circumferential barrier and the outer circumferential barrier. The support structure also includes a plurality of second ribs extending between the inner circumferential barrier and the outer circumferential barrier. At least some of the first ribs intersect at least some of the second ribs, such that intersecting first ribs and second ribs share common material at points of intersection. At least some of the first ribs extend in a first circumferential direction, each defining a first angle relative to a first line tangent to the inner circumferential barrier at a point where the at least some first ribs meet the inner circumferential barrier. At least some of the second ribs extend in a second circumferential direction, each defining a second angle relative to a second line tangent to the inner circumferential barrier at a point where the at least some second ribs meet the inner circumferential barrier.

In another aspect, a wheel includes a hub configured to be coupled to a machine, and a non-pneumatic tire coupled to the hub. The tire includes an inner circumferential barrier coupled to the hub, an outer circumferential barrier radially spaced from the inner circumferential barrier, and a support structure. The support structure extends between the inner circumferential barrier and the outer circumferential barrier and couples the inner circumferential barrier to the outer circumferential barrier. The support structure includes a plurality of first ribs extending between the inner circumferential barrier and the outer circumferential barrier. The first ribs have a cross-section substantially perpendicular to an axial direction of the tire, with the cross-section having a first curvilinear shape. The first curvilinear shape is a curve having either a single direction of curvature or a direction of curvature that changes once as the first ribs extend between the inner circumferential barrier and the outer circumferential barrier. The support structure also includes a plurality of second ribs extending between the inner circumferential barrier and the outer circumferential barrier. At least some of the first ribs intersect at least some of the second ribs, such that intersecting first ribs and second ribs share common material at points of intersection. At least some of the first ribs extend in a first circumferential direction, each defining a first angle relative to a first line tangent to the inner circumferential barrier at a point where the at least some first ribs meet the inner circumferential barrier. At least some of the second ribs extend in a second circumferential direction, each defining a second angle relative to a second line tangent to the inner circumferential barrier at a point where the at least some second ribs meet the inner circumferential barrier.

In still a further aspect, a machine configured to travel across terrain includes at least one wheel coupled to the machine. The at least one wheel includes a hub coupled to the machine and a non-pneumatic tire coupled to the hub. The tire includes an inner circumferential barrier coupled to the hub, an outer circumferential barrier radially spaced from the inner circumferential barrier, and a support structure. The support structure extends between the inner circumferential barrier and the outer circumferential barrier and couples the inner circumferential barrier to the outer circumferential barrier. The support structure includes a plurality of first ribs extending between the inner circumferential barrier and the outer circumferential barrier. The first ribs have a cross-section substantially perpendicular to an axial direction of the tire, with the cross-section having a first curvilinear shape. The first curvilinear shape is a curve having either a single direction of curvature or a direction of curvature that changes once as the first ribs extend between the inner circumferential barrier and the outer circumferential barrier. The support structure further includes a plurality of second ribs extending between the inner circumferential barrier and the outer circumferential barrier. At least some of the first ribs intersect at least some of the second ribs, such that intersecting first ribs and second ribs share common material at points of intersection. At least some of the first ribs extend in a first circumferential direction, each defining a first angle relative to a first line tangent to the inner circumferential barrier at a point where the at least some first ribs meet the inner circumferential barrier. At least some of the second ribs extend in a second circumferential direction, each defining a second angle relative to a second line tangent to the inner circumferential barrier at a point where the at least some second ribs meet the inner circumferential barrier.

According to still a further aspect, a non-pneumatic tire includes an inner circumferential barrier configured to be coupled to a hub, an outer circumferential barrier radially spaced from the inner circumferential barrier, and a support structure extending between the inner circumferential barrier and the outer circumferential barrier and coupling the inner circumferential barrier to the outer circumferential barrier. The support structure at least partially defines a first axial side of the tire and a second axial side of the tire opposite the first axial side of the tire. The support structure includes a plurality of ribs extending between the inner circumferential barrier and the outer circumferential barrier, wherein the plurality of ribs define a plurality of cavities extending between the first axial side of the tire and the second axial side of the tire. At least some of the cavities each define an axial cross-section that varies at points between the first axial side of the tire and the second axial side of the tire.

According to still another aspect, a wheel includes a hub configured to be coupled to a machine, and a non-pneumatic tire coupled to the hub. The tire includes an inner circumferential barrier configured to be coupled to the hub, an outer circumferential barrier radially spaced from the inner circumferential barrier, and a support structure extending between the inner circumferential barrier and the outer circumferential barrier and coupling the inner circumferential barrier to the outer circumferential barrier. The support structure at least partially defines a first axial side of the tire and a second axial side of the tire opposite the first axial side of the tire. The support structure includes a plurality of ribs extending between the inner circumferential barrier and the outer circumferential barrier, wherein the plurality of ribs define a plurality of cavities extending between the first axial side of the tire and the second axial side of the tire. At least some of the cavities each define an axial cross-section that varies at points between the first axial side of the tire and the second axial side of the tire.

In still a further aspect, a machine configured to travel across terrain includes at least one wheel. The at least one wheel includes a hub coupled to the machine and a non-pneumatic tire coupled to the hub. The tire includes an inner circumferential barrier coupled to the hub, an outer circumferential barrier radially spaced from the inner circumferential barrier, and a support structure extending between the inner circumferential barrier and the outer circumferential barrier and coupling the inner circumferential barrier to the outer circumferential barrier. The support structure at least partially defines a first axial side of the tire and a second axial side of the tire opposite the first axial side of the tire. The support structure includes a plurality of ribs extending between the inner circumferential barrier and the outer circumferential barrier, wherein the plurality of ribs define a plurality of cavities extending between the first axial side of the tire and the second axial side of the tire. At least some of the cavities each define an axial cross-section that varies at points between the first axial side of the tire and the second axial side of the tire.

In still another aspect, a non-pneumatic tire includes an inner circumferential barrier configured to be coupled to a hub, an outer circumferential barrier radially spaced from the inner circumferential barrier, and a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier. The support structure at least partially defines a first axial side of the tire and a second axial side of the tire opposite the first axial side of the tire. The first and second axial sides of the tire define an axial width of the support structure. The axial width of the support structure varies as the support structure extends between the inner circumferential barrier and the outer circumferential barrier.

According to yet another aspect, a non-pneumatic tire includes an inner circumferential barrier configured to be coupled to a hub, an outer circumferential barrier radially spaced from the inner circumferential barrier, and a tread portion associated with the outer circumferential barrier. The tire further includes a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier, wherein the ribs have a cross-section substantially perpendicular to an axial direction of the tire, with the cross-section having a curvilinear shape. The curvilinear shape is a curve having either a single direction of curvature or a direction of curvature that changes once as the ribs extend between the inner circumferential barrier and the outer circumferential barrier. The inner circumferential barrier defines an inner diameter of the tire, and the tread portion defines an outer diameter of the tire, wherein a ratio of the inner diameter of the tire to the outer diameter of the tire ranges from 0.25:1 to 0.75:1.

According to a further aspect, a wheel includes a hub configured to be coupled to a machine, and a non-pneumatic tire coupled to the hub. The tire includes an inner circumferential barrier coupled to the hub, an outer circumferential barrier radially spaced from the inner circumferential barrier, and a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier, wherein the support structure at least partially defines a first axial side of the tire and a second axial side of the tire opposite the first axial side of the tire. The first and second axial sides of the tire define an axial width of the support structure, and the axial width of the support structure varies as the support structure extends between the inner circumferential barrier and the outer circumferential barrier.

According to still a further aspect, a wheel includes a hub configured to be coupled to a machine, and a non-pneumatic tire coupled to the hub. The tire includes an inner circumferential barrier coupled to the hub, an outer circumferential barrier radially spaced from the inner circumferential barrier, and a tread portion associated with the outer circumferential barrier. The tire further includes a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier, wherein the ribs have a cross-section substantially perpendicular to an axial direction of the tire, with the cross-section having a curvilinear shape. The curvilinear shape is a curve having either a single direction of curvature or a direction of curvature that changes once as the ribs extend between the inner circumferential barrier and the outer circumferential barrier. The inner circumferential barrier defines an inner diameter of the tire, and the tread portion defines an outer diameter of the tire, wherein a ratio of the inner diameter of the tire to the outer diameter of the tire ranges from 0.25:1 to 0.75:1.

According to yet another aspect, a machine configured to travel across terrain includes at least one wheel. The at least one wheel includes a hub coupled to the machine, and a non-pneumatic tire coupled to the hub. The tire includes an inner circumferential barrier coupled to the hub, an outer circumferential barrier radially spaced from the inner circumferential barrier, and a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier, wherein the support structure at least partially defines a first axial side of the tire and a second axial side of the tire opposite the first axial side of the tire. The first and second axial sides of the tire define an axial width of the support structure, and the axial width of the support structure varies as the support structure extends between the inner circumferential barrier and the outer circumferential barrier.

According to a further aspect, a machine configured to travel across terrain includes at least one wheel. The at least one wheel includes a hub coupled to the machine, and a non-pneumatic tire coupled to the hub. The tire includes an inner circumferential barrier coupled to the hub, an outer circumferential barrier radially spaced from the inner circumferential barrier, and a tread portion associated with the outer circumferential barrier. The tire further includes a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier, wherein the ribs have a cross-section in an axial direction of the tire having a curvilinear shape. The curvilinear shape is a curve having either a single direction of curvature or a direction of curvature that changes once as the ribs extend between the inner circumferential barrier and the outer circumferential barrier. The inner circumferential barrier defines an inner diameter of the tire, and the tread portion defines an outer diameter of the tire, wherein a ratio of the inner diameter of the tire to the outer diameter of the tire ranges from 0.25:1 to 0.75:1.

According to yet another aspect, a non-pneumatic tire includes an inner circumferential barrier configured to be coupled to a hub, an outer circumferential barrier radially spaced from the inner circumferential barrier, and a support structure extending between the inner circumferential barrier and the outer circumferential barrier and coupling the inner circumferential barrier to the outer circumferential barrier. The support structure at least partially defines a first axial side of the tire and a second axial side of the tire opposite the first axial side of the tire. The support structure includes a plurality of first ribs extending between the inner circumferential barrier and the outer circumferential barrier, and a plurality of second ribs extending between the inner circumferential barrier and the outer circumferential barrier. At least some of the plurality of first ribs extend from the first axial side of the tire toward the second axial side of the tire, and at least some of the plurality of second ribs extend from the second axial side of the tire toward the first axial side of the tire. The at least some first ribs extend partially from the first axial side of the tire toward the second axial side of the tire, such that the at least some first ribs terminate prior to reaching the second axial side of the tire.

According to a further aspect, a non-pneumatic tire includes an inner circumferential barrier configured to be coupled to a hub, an outer circumferential barrier radially spaced from the inner circumferential barrier, and a support structure extending between the inner circumferential barrier and the outer circumferential barrier and coupling the inner circumferential barrier to the outer circumferential barrier. The support structure includes a plurality of first ribs extending between the inner circumferential barrier and the outer circumferential barrier, and a plurality of second ribs extending between the inner circumferential barrier and the outer circumferential barrier. The support structure further includes at least one web extending circumferentially about the inner circumferential barrier and at least partially between the inner circumferential barrier and the outer circumferential barrier, wherein the at least one web intersects at least some of the plurality of first ribs and at least some of the plurality of second ribs.

According to another aspect, a wheel includes a hub configured to be coupled to a machine, and a non-pneumatic tire coupled to the hub. The tire includes an inner circumferential barrier coupled to the hub, an outer circumferential barrier radially spaced from the inner circumferential barrier, and a support structure extending between the inner circumferential barrier and the outer circumferential barrier and coupling the inner circumferential barrier to the outer circumferential barrier. The support structure at least partially defines a first axial side of the tire and a second axial side of the tire opposite the first axial side of the tire. The support structure includes a plurality of first ribs extending between the inner circumferential barrier and the outer circumferential barrier, and a plurality of second ribs extending between the inner circumferential barrier and the outer circumferential barrier. At least some of the plurality of first ribs extend from the first axial side of the tire toward the second axial side of the tire, and at least some of the plurality of second ribs extend from the second axial side of the tire toward the first axial side of the tire. The at least some first ribs extend partially from the first axial side of the tire toward the second axial side of the tire, such that the at least some first ribs terminate prior to reaching the second axial side of the tire.

According to yet another aspect, a wheel includes a hub configured to be coupled to a machine, and a non-pneumatic tire coupled to the hub. The tire includes an inner circumferential barrier coupled to the hub, an outer circumferential barrier radially spaced from the inner circumferential barrier, and a support structure extending between the inner circumferential barrier and the outer circumferential barrier and coupling the inner circumferential barrier to the outer circumferential barrier. The support structure includes a plurality of first ribs extending between the inner circumferential barrier and the outer circumferential barrier, and a plurality of second ribs extending between the inner circumferential barrier and the outer circumferential barrier. The support structure further includes at least one web extending circumferentially about the inner circumferential barrier and at least partially between the inner circumferential barrier and the outer circumferential barrier, wherein the at least one web intersects at least some of the plurality of first ribs and at least some of the plurality of second ribs.

According to still a further aspect, a machine configured to travel across terrain includes at least one wheel. The at least one wheel includes a hub coupled to the machine, and a non-pneumatic tire coupled to the hub. The tire includes an inner circumferential barrier coupled to the hub, an outer circumferential barrier radially spaced from the inner circumferential barrier, and a support structure extending between the inner circumferential barrier and the outer circumferential barrier and coupling the inner circumferential barrier to the outer circumferential barrier. The support structure at least partially defines a first axial side of the tire and a second axial side of the tire opposite the first axial side of the tire. The support structure includes a plurality of first ribs extending between the inner circumferential barrier and the outer circumferential barrier, and a plurality of second ribs extending between the inner circumferential barrier and the outer circumferential barrier. At least some of the plurality of first ribs extend from the first axial side of the tire toward the second axial side of the tire, and at least some of the plurality of second ribs extend from the second axial side of the tire toward the first axial side of the tire. The at least some first ribs extend partially from the first axial side of the tire toward the second axial side of the tire, such that the at least some first ribs terminate prior to reaching the second axial side of the tire.

According to yet another aspect, a machine configured to travel across terrain includes at least one wheel. The at least one wheel includes a hub coupled to the machine, and a non-pneumatic tire coupled to the hub. The tire includes an inner circumferential barrier coupled to the hub, an outer circumferential barrier radially spaced from the inner circumferential barrier, and a support structure extending between the inner circumferential barrier and the outer circumferential barrier and coupling the inner circumferential barrier to the outer circumferential barrier. The support structure includes a plurality of first ribs extending between the inner circumferential barrier and the outer circumferential barrier, and a plurality of second ribs extending between the inner circumferential barrier and the outer circumferential barrier. The support structure further includes at least one web extending circumferentially about the inner circumferential barrier and at least partially between the inner circumferential barrier and the outer circumferential barrier, wherein the at least one web intersects at least some of the plurality of first ribs and at least some of the plurality of second ribs.

According to another aspect, a non-pneumatic tire includes an inner circumferential barrier configured to be coupled to a hub, an outer circumferential barrier radially spaced from the inner circumferential barrier, and a tread portion associated with the outer circumferential barrier. The tire further includes a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier, wherein the ribs have a cross-section substantially perpendicular to an axial direction of the tire, with the cross-section having a curvilinear shape. The curvilinear shape is a curve having either a single direction of curvature or a direction of curvature that changes once as the ribs extend between the inner circumferential barrier and the outer circumferential barrier. The tread portion defines a first edge and a second edge opposite the first edge. The tread portion further defines a plurality of circumferentially spaced first transverse grooves associated with the first edge, a plurality of circumferentially spaced second transverse grooves associated with the second edge, and a circumferential tread rib separating the first grooves and the second grooves from one another.

According to a further aspect, a wheel includes a hub configured to be coupled to a machine, and a non-pneumatic tire coupled to the hub. The tire includes an inner circumferential barrier configured to be coupled to a hub, an outer circumferential barrier radially spaced from the inner circumferential barrier, and a tread portion associated with the outer circumferential barrier. The tire further includes a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier, wherein the ribs have a cross-section substantially perpendicular to an axial direction of the tire, with the cross-section having a curvilinear shape. The curvilinear shape is a curve having either a single direction of curvature or a direction of curvature that changes once as the ribs extend between the inner circumferential barrier and the outer circumferential barrier. The tread portion defines a first edge and a second edge opposite the first edge, a plurality of circumferentially spaced first transverse grooves associated with the first edge, a plurality of circumferentially spaced second transverse grooves associated with the second edge, and a circumferential tread rib separating the first grooves and the second grooves from one another.

According to still a further aspect, a machine configured to travel across terrain includes at least one wheel. The at least one wheel includes a hub coupled to the machine, and a non-pneumatic tire coupled to the hub. The tire includes an inner circumferential barrier coupled to the hub, an outer circumferential barrier radially spaced from the inner circumferential barrier, and a tread portion associated with the outer circumferential barrier. The tire further includes a support structure extending between the inner circumferential barrier and the outer circumferential barrier and coupling the inner circumferential barrier to the outer circumferential barrier. The support structure includes a plurality of ribs extending between the inner circumferential barrier and the outer circumferential barrier. The ribs have a cross-section substantially perpendicular to an axial direction of the tire, with the cross-section having a curvilinear shape. The curvilinear shape is a curve having either a single direction of curvature or a direction of curvature that changes once as the ribs extend between the inner circumferential barrier and the outer circumferential barrier. The tread portion defines a first edge and a second edge opposite the first edge, a plurality of circumferentially spaced first transverse grooves associated with the first edge, a plurality of circumferentially spaced second transverse grooves associated with the second edge, and a circumferential tread rib separating the first grooves and the second grooves from one another.

### BRIEF DESCRIPTION OF THE DRAWINGS

FIG. 1 is a side view of an exemplary embodiment of a machine including an exemplary embodiment of a non-pneumatic tire.

FIG. 2A is a perspective view of an exemplary embodiment of a non-pneumatic tire.

FIG. 2B is a side view of the exemplary embodiment shown in FIG. 2A.

FIG. 3A is a partial side view of an exemplary embodiment of a non-pneumatic tire.

FIG. 3B is a partial side view of an exemplary embodiment of a non-pneumatic tire.

FIG. 4 is a side view of another exemplary embodiment of a non-pneumatic tire.

FIG. 5A is a partial side view of an exemplary embodiment of a non-pneumatic tire.

FIG. 5B is a partial side view of another exemplary embodiment of a non-pneumatic tire.

FIG. 6 is a side view of another exemplary embodiment of a non-pneumatic tire.

FIG. 7A is a partial, perspective section view of an exemplary embodiment of a non-pneumatic tire.

FIG. 7B is a partial, perspective section view of another exemplary embodiment of a non-pneumatic tire.

FIG. 8A is a partial, side view of another exemplary embodiment of a non-pneumatic tire.

FIG. 8B is a partial, perspective section view of the exemplary embodiment shown in FIG. 8A.

FIG. 9A is a partial, side view of another exemplary embodiment of a non-pneumatic tire.

FIG. 9B is a partial, perspective view of the exemplary embodiment shown in FIG. 9A.

FIG. 10A is a partial, side view of another exemplary embodiment of a non-pneumatic tire.

FIG. 10B is a partial, perspective view of the exemplary embodiment shown in FIG. 10A.

FIG. 11A is a partial, perspective section view of an exemplary embodiment of a non-pneumatic tire.

FIG. 11B is a partial, perspective section view of another exemplary embodiment of a non-pneumatic tire.

FIG. 11C is a partial, perspective section view of another exemplary embodiment of a non-pneumatic tire.

FIG. 11D is a partial, perspective section view of a further exemplary embodiment of a non-pneumatic tire.

FIG. 11E is a partial, perspective section view of a further exemplary embodiment of a non-pneumatic tire.

FIG. 12A is a partial, perspective section view of an exemplary embodiment of a non-pneumatic tire.

FIG. 12B is a partial, perspective section view of another exemplary embodiment of a non-pneumatic tire.

FIG. 12C is a partial, perspective section view of a further exemplary embodiment of a non-pneumatic tire.

FIG. 13 is a partial, perspective section view of another exemplary embodiment of a non-pneumatic tire.

FIG. 14A is a side view of a portion of an exemplary embodiment of a non-pneumatic tire.

FIG. 14B is a perspective view of an exemplary embodiment of a non-pneumatic tire formed with the portion shown in FIG. 14A.

FIG. 14C is an end view of the exemplary embodiment of non-pneumatic tire shown in FIG. 14B.

FIG. 14D is a side view of the exemplary embodiment of non-pneumatic tire shown in FIGS. 14B and 14C.

FIG. 15A is a perspective view of exemplary embodiments of two non-pneumatic tire portions in an unjoined condition.

FIG. 15B is an end view of a tire formed with the two exemplary non-pneumatic tire portions shown in FIG. 15A.

FIG. 16A is a side view of an exemplary embodiment of a non-pneumatic tire.

FIG. 16B is an end view of the exemplary embodiment of non-pneumatic tire shown in FIG. 16A.

FIG. 16C is a view showing an exemplary contact patch of the exemplary embodiment of non-pneumatic tire shown in FIGS. 16A and 16B.

FIG. 16D is a side view of the exemplary embodiment of non-pneumatic tire shown in FIGS. 16A-16C when loaded.

FIG. 17A is an end view of an exemplary embodiment of a non-pneumatic tire.

FIG. 17B is an end view of another exemplary embodiment of a non-pneumatic tire.

### DETAILED DESCRIPTION

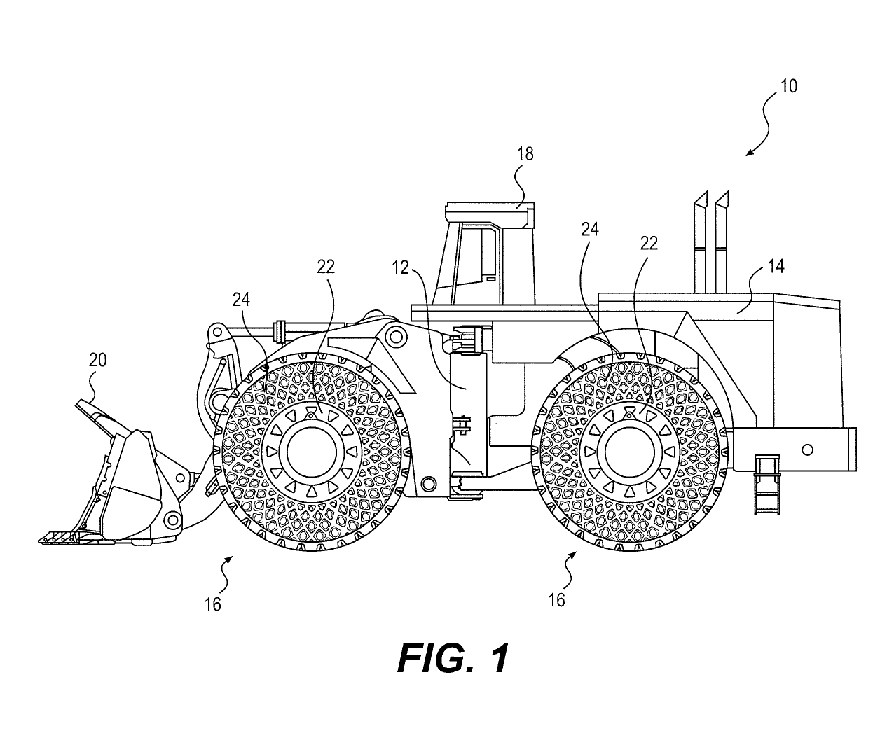

FIG. 1 shows an exemplary machine 10 configured to travel across terrain. Exemplary machine 10 shown in FIG. 1 is a wheel loader. However, machine 10 may be any type of ground-borne vehicle, such as, for example, an automobile, a truck, an agricultural vehicle, and/or a construction vehicle, such as, for example, a dozer, a skid-steer loader, an excavator, a grader, an on-highway truck, an off-highway truck, and/or any other vehicle type known to a person skilled in the art. In addition to self-propelled machines, machine 10 may be any device configured to travel across terrain via assistance or propulsion from another machine.

Exemplary machine 10 shown in FIG. 1 includes a chassis 12 and a powertrain 14 coupled to and configured to supply power to wheels 16, so that machine 10 is able to travel across terrain. Machine 10 also includes an operator station 18 to provide an operator interface and protection for an operator of machine 10. Machine 10 also includes a bucket 20 configured to facilitate movement of material. As shown in FIG. 1, exemplary wheels 16 include a hub 22 coupled to powertrain 14, and tires 24 coupled to hubs 22. Exemplary tires 24 are non-pneumatic.

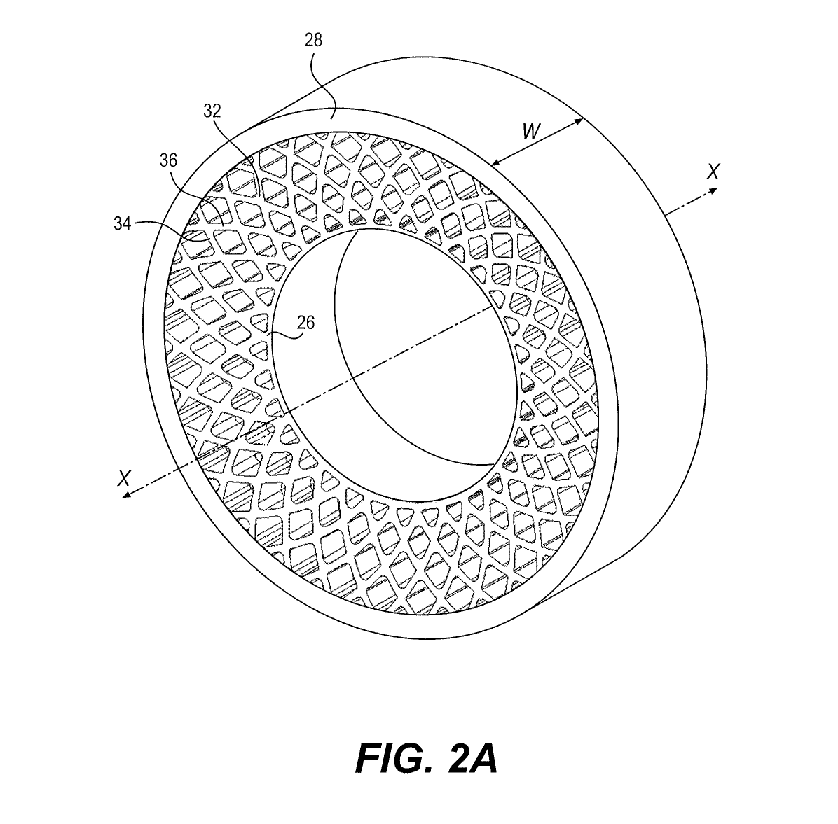

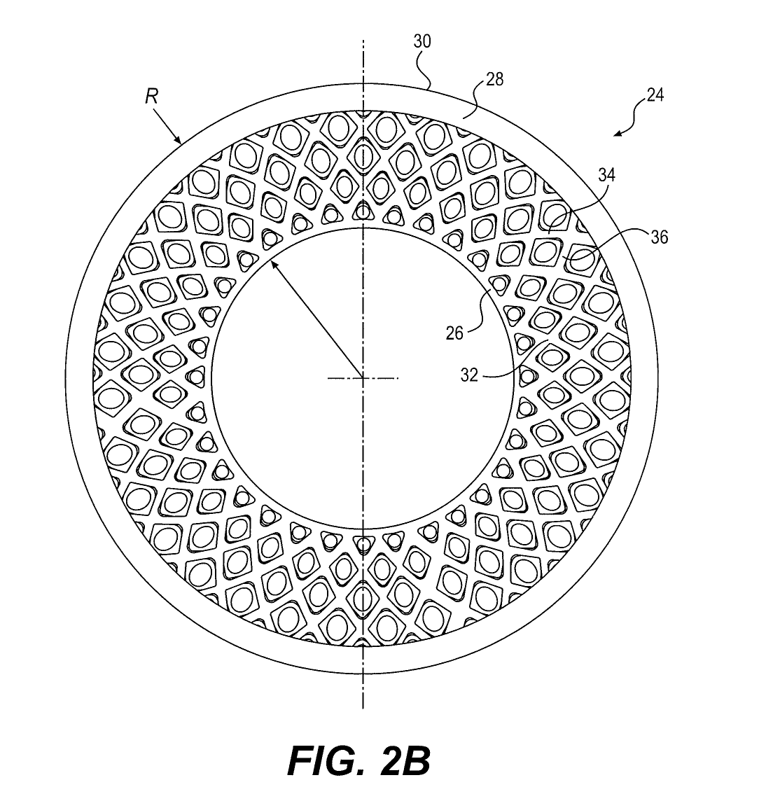

The exemplary tire 24 shown in FIGS. 2A and 2B includes an inner circumferential barrier 26 barrier configured to be coupled to a hub 22, and an outer circumferential barrier 28 configured to be coupled to, or provided with, a tread portion 30 configured to improve traction of the tire at the interface between tire 24 and the terrain across which tire 24 rolls. Extending between inner circumferential barrier 26 and outer circumferential barrier 28 is a support structure 32. Exemplary support structure 32 serves to couple inner circumferential barrier 26 and outer circumferential barrier 28 to one another. Hub 22 and/or inner circumferential barrier 26 may be configured to facilitate coupling of hub 22 to inner circumferential barrier 26.

Although the drawings show lines between support structure 32 and inner and outer circumferential barriers 26 and 28 for clarity, such lines do not necessarily indicate that support structure 32, inner circumferential barrier 26, and/or outer circumferential barrier 28 are separate parts that are assembled to one another. For example, according to some embodiments, support structure 32, inner circumferential barrier 26, and/or outer circumferential barrier 28 are integrally formed as a single, monolithic piece, for example, via molding. However, it is also contemplated that support structure 32, inner circumferential barrier 26, and/or outer circumferential barrier 28 may be formed separately and thereafter coupled to one another via adhesives and/or mechanical methods (e.g., via fasteners and/or complementary portions on adjacent parts.)

Tire 24, including inner circumferential barrier 26, outer circumferential barrier 28, tread portion 30, and support structure 32, may be configured to provide a desired amount of traction and cushioning between machine 10 and the terrain. For example, support structure 32 may be configured to support machine 10 in a loaded, partially loaded, and empty condition, such that a desired amount of traction and/or cushioning is provided, regardless of the load.

For example, exemplary machine 10 is a wheel loader. When bucket 20 is empty, the load on one or more of wheels 16 may range from about 60,000 lbs. to about 160,000 lbs. (e.g., 120,000 lbs.) In contrast, with bucket 20 loaded with material, the load on one or more of wheels 16 may range from about 200,000 lbs. to about 400,000 lbs. (e.g., 350,000 lbs.). Tire 24 may be configured to provide a desired level of traction and cushioning, regardless of whether bucket 20 is loaded, partially loaded, or empty. For smaller machines, correspondingly lower loads are contemplated. For example, for a skid-steer loader, the load on one or more of wheels 16 may range from about 1,000 lbs. empty to about 3,000 lbs. (e.g., 2,400 lbs.) loaded.

Referring to FIGS. 2A and 2B, at least some of first ribs 34 and second ribs 36 have a width Win the axial direction defined by an axis X of tire 24, and tire 24 has a radial distance R between inner circumferential barrier 26 and outer circumferential barrier 28. According to some embodiments, the ratio of the radial distance R to the width W ranges from 0.3:1 to 1.5:1, for example, from 0.6:1 to 1:1. This ratio may be selected to tailor weight and/or cushioning characteristics of tire 24 to a desired level.

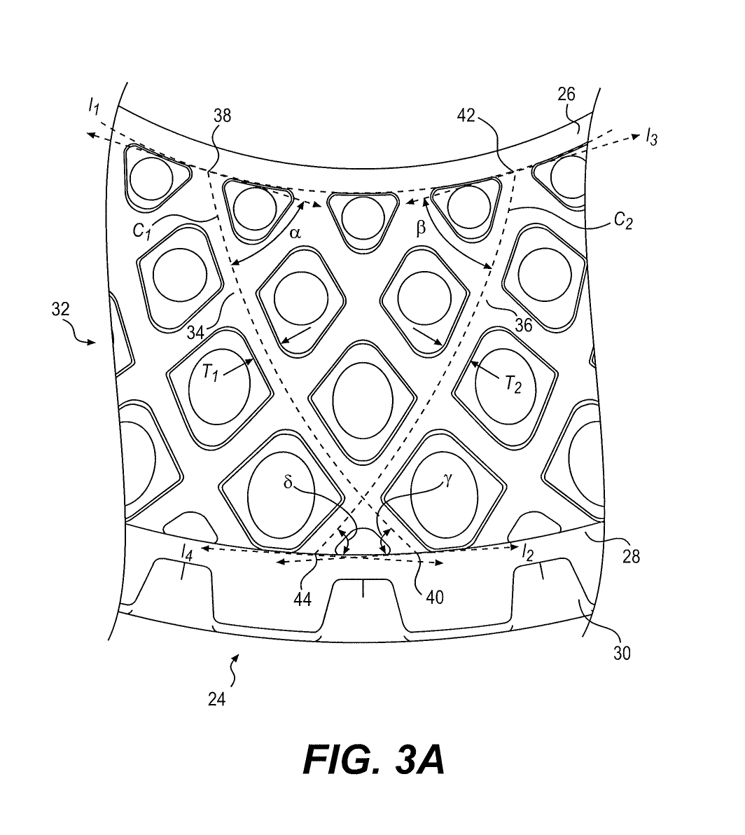

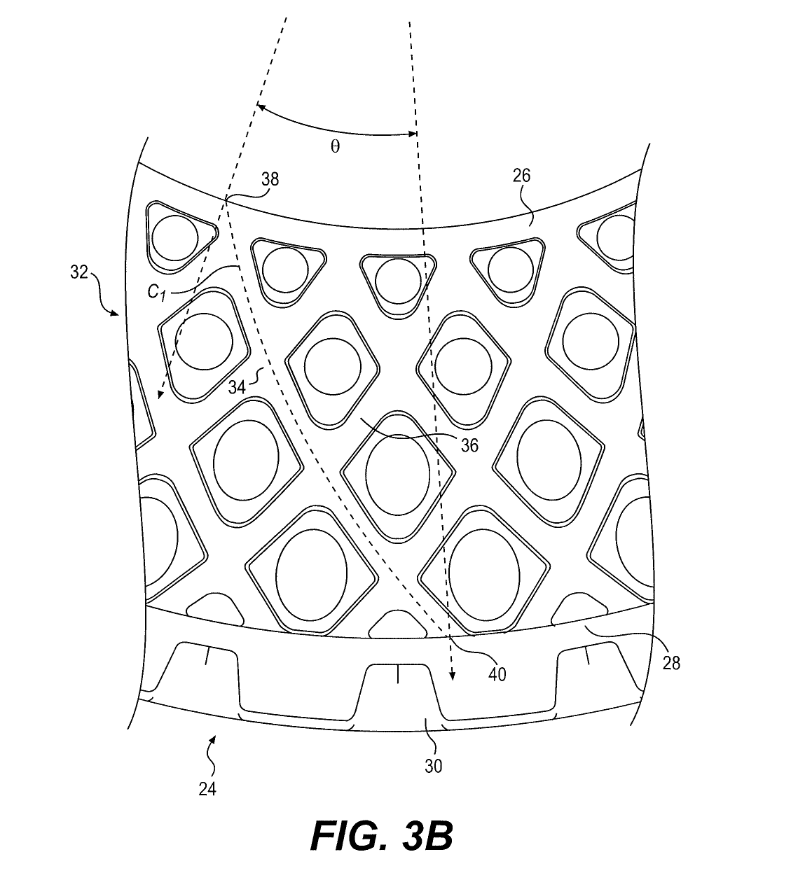

FIG. 3A shows an axial cross-section perpendicular to the axial direction of tire 24 defined by the axis X (see FIG. 2A) of a portion of an exemplary embodiment of tire 24. Exemplary tire 24 shown in FIG. 3A includes a support structure 32 having a plurality of first ribs 34 extending in a first circumferential direction between inner circumferential barrier 26 and outer circumferential barrier 28. For example, in some embodiments, at least some of first ribs 34 are coupled to inner circumferential barrier 26 and outer circumferential barrier 28 and extend therebetween, as shown in FIG. 3A. Similarly, in some embodiments, support structure 32 includes a plurality of second ribs 36 extending in a second circumferential direction opposite the first circumferential direction between inner circumferential barrier 26 and outer circumferential barrier 28. For example, in some embodiments, at least some of second ribs 36 are coupled to inner circumferential barrier 26 and outer circumferential barrier 28 and extend therebetween, as shown in FIG. 3A. According to some embodiments, at least some of first ribs 34 and some of second ribs 36 intersect one another such that they share common material at points of intersection. For example, at least one of first ribs 34 intersects at least two of second ribs 36, for example, at least four of second ribs 36.

As shown in FIG. 3A, exemplary first ribs 34 extend in the first circumferential direction, with each of first ribs 34 defining a first inner angle a relative to a first line l₁ tangent to inner circumferential barrier 26 at an inner point of attachment 38, where the respective first rib 34 meets inner circumferential barrier 26. Each of first ribs 34 may define a first outer angle γ relative to a second line l₂ tangent to outer circumferential barrier 28 at an outer point of attachment 40, where the respective first rib 34 meets outer circumferential barrier 28. Similarly, exemplary second ribs 36 extend in the second circumferential direction, with each of second ribs 36 defining a second inner angle β relative to a third line l₃ tangent to inner circumferential barrier 26 at an inner point of attachment 42, where the respective second rib 36 meets inner circumferential barrier 26. Each of second ribs 36 may define a second outer angle δ relative to a fourth line l₄ tangent to outer circumferential barrier 28 at an outer point of attachment 44, where the respective second rib 36 meets outer circumferential barrier 28.

According to some embodiments, first inner angle α and second inner angle β are substantially equal to one another, and first outer angle γ and second outer angle δ are substantially equal to one another, with first and second inner angles α and β being greater than first and second outer angles γ and δ. According to some embodiments, first inner angle α ranges from 30 to 85 degrees, for example, from 40 to 80 degrees, or from 55 to 75 degrees (e.g., about 65 degrees). According to some embodiments, first outer angle γ ranges from 25 to 70 degrees, for example, from 35 to 65 degrees, or from 40 to 60 degrees (e.g., about 50 degrees). According to some embodiments, second inner angle β ranges from 30 to 85 degrees, for example, from 40 to 80 degrees, or from 55 to 75 degrees (e.g., about 65 degrees). According to some embodiments, second outer angle b ranges from 25 to 70 degrees, for example, from 35 to 65 degrees, or from 40 to 60 degrees (e.g., about 50 degrees).

One or more of first inner angle α, first outer angle γ, second inner angle β, and second outer angle δ may be selected to provide a desired level of cushioning for tire 24. For example, as the angles are increased toward 90 degrees, the cushioning provided by tire 24 may become relatively more firm. In contrast, as the angles are decreased toward zero degrees, the cushioning of tire 24 may become relatively softer.

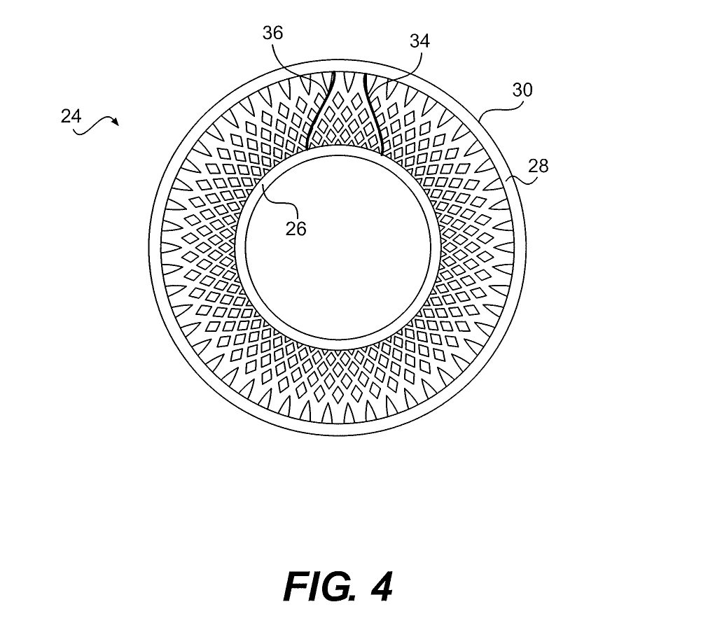

As shown in FIG. 3A, according to some embodiments, each of first ribs 34 may have a cross-section perpendicular to the axial direction having a first curvilinear shape. In some embodiments, the first curvilinear shape may be a curve having a single direction of curvature (see, e.g., FIG. 3A) as first ribs 34 extend between inner circumferential barrier 26 and outer circumferential barrier 28. In some embodiments, the first curvilinear shape may be a curve having a direction of curvature that changes once (see, e.g., FIG. 4, highlighting one of first ribs 34) as first ribs 34 extend between inner circumferential barrier 26 and outer circumferential barrier 28. Similarly, each of second ribs 36 may have a cross-section perpendicular the axial direction of tire 24 having a second curvilinear shape. In some embodiments, the second curvilinear shape may be a curve having a single direction of curvature (see, e.g., FIG. 3A) as second ribs 36 extend between inner circumferential barrier 26 and outer circumferential barrier 28. In some embodiments, the second curvilinear shape may be a curve having a direction of curvature that changes once (see, e.g., FIG. 4, highlighting one of second ribs 36) as second ribs 36 extend between inner circumferential barrier 26 and outer circumferential barrier 28. According to some embodiments, the first and/or second curvilinear shapes may be generally defined by respective center lines C₁ and C₂ (see FIG. 3A). According to some embodiments, center lines C₁ and C₂ of respective first ribs 34 and/or second ribs 36 may define sweeping curves that do not include discontinuities in the respective sweeping curves.

According to some embodiments, the first and/or second curvilinear shapes may have a radius of curvature that varies as the respective first ribs 34 and/or second ribs 36 extend between inner circumferential barrier 26 and outer circumferential barrier 28. For example, the radius may increase as the respective first ribs 34 and/or second ribs 36 extend from inner circumferential barrier 26 to outer circumferential barrier 28. Alternatively, the radius of curvature may decrease as the respective first ribs 34 and/or second ribs 36 extend from inner circumferential barrier 26 to outer circumferential barrier 28.

The first and second curvilinear shapes may affect the relative cushioning and/or durability of tire 24. For example, having only a single direction of curvature or a single change in direction of curvature may prevent or reduce the likelihood of first ribs 34 or second ribs 36 buckling or collapsing under load. This may be a result first and second ribs 34 and 36 supporting one another and/or acting primarily in compression rather than primarily in tension when placed under load.

Referring to FIG. 3A, first ribs 34 and second ribs 36 have respective thicknesses T₁ and T₂. According to some embodiments, thicknesses T₁ and/or T₂ may remain constant as first and second ribs 34 and 36 extend from inner circumferential barrier 26 to outer circumferential barrier 28. According to some embodiments, thicknesses T₁ and/or T₂ may vary as first and second ribs 34 and 36 extend from inner circumferential barrier 26 to outer circumferential barrier 28. For example, thicknesses T₁ and/or T₂ may increase as first and second ribs 34 and 36 extend from inner circumferential barrier 26 to outer circumferential barrier 28. Alternatively, thicknesses T₁ and/or T₂ may decrease as they extend from inner circumferential barrier 26 to outer circumferential barrier 28.

As shown in FIG. 3A, at least some of first ribs 34 have inner points of attachment 38 to inner circumferential barrier 26 and respective outer points of attachment 40 to outer circumferential barrier 28. For example, an inner point of attachment 38 of one of first ribs 34 to inner circumferential barrier 26 may be circumferentially separated from a respective outer point of attachment 40 to outer circumferential barrier 28 by from 10 to 30 degrees (e.g., about 20 degrees). Similarly, at least some of second ribs 36 have inner points of attachment 42 to inner circumferential barrier 26 and respective outer points of attachment 44 to outer circumferential barrier 28. For example, an inner point of attachment 42 of one of second ribs 36 to inner circumferential barrier 26 may be circumferentially separated from a respective outer point of attachment 44 to outer circumferential barrier 28 by from 10 to 30 degrees (e.g., 20 degrees).

For example, as shown in FIG. 3B, first ribs 34 have a center line C₁ and extend between inner point of attachment 38 and outer point of attachment 40, such that a rib sweep angle θ defines the circumferential angle through which first rib 34 sweeps as it extends from inner circumferential barrier 26 to outer circumferential barrier 28. Although not depicted in FIG. 3B, second ribs 36 may have the same, similar, or different sweep angle. According to some embodiments, rib sweep angle θ may range from 5 to 40 degrees, from 10 to 30 degrees, or from 15 to 25 degrees (e.g., about 20 degrees).

Exemplary tire 24 may include any number of first ribs 34 and second ribs 36 to provide the desired cushioning characteristic. For example, tire 24 may include from 20 to 60 first ribs 34 and from 20 to 60 second ribs 36. According to some embodiments, tire 24 may include from 25 to 45 first ribs 34 and from 25 to 45 second ribs 36. According to some embodiments, tire 24 may include 32 first ribs 34 and 32 second ribs 36. For some embodiments, first and/or second ribs 34 and 36 may be evenly spaced circumferentially about tire 24. According to some embodiments, first and/or second ribs 34 and 36 may be unevenly spaced circumferentially about tire 24.

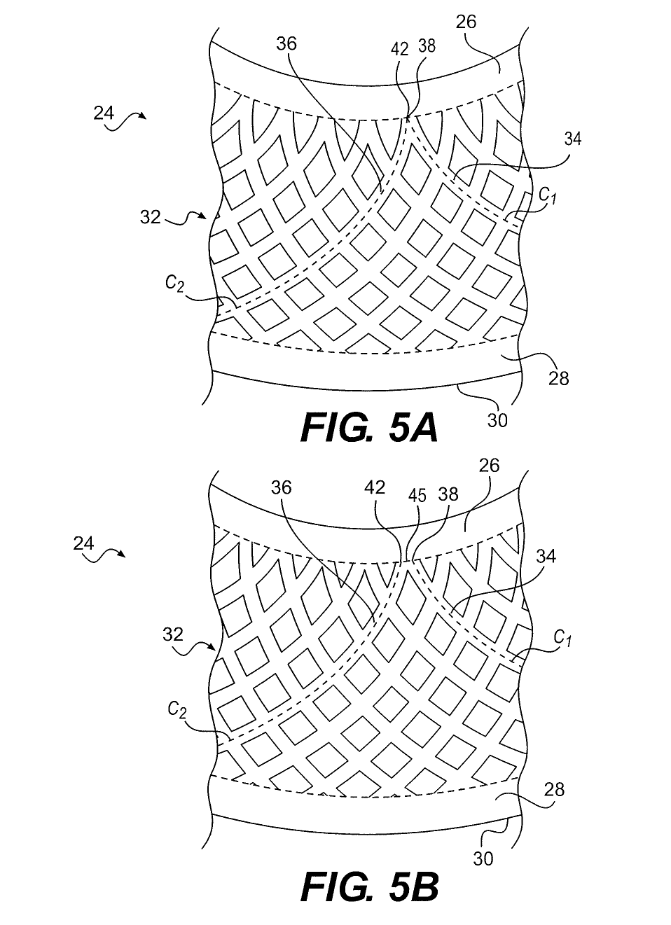

As shown in FIG. 5A, some embodiments of tire 24 are configured such that respective inner points of attachment 38 of first ribs 34 are located at the same circumferential position as respective inner points of attachment 42 of second ribs 36. Alternatively, as shown in FIG. 5B, some embodiments of tire 24 are configured such that respective inner points of attachment 38 of first ribs 34 are circumferentially spaced from respective inner points of attachment 42 of second ribs 36. For example, inner points of attachment 38 of first ribs 34 may be circumferentially spaced from inner points of attachment 42 of second ribs 36 by from zero to 15 degrees, for example, from 9 to 13 degrees. For example, for the exemplary embodiment shown in FIG. 5B, there is a circumferential gap 45 of about 1.5 degrees between first center line C₁ of first rib 34 and second center line C₂ of second rib 36.

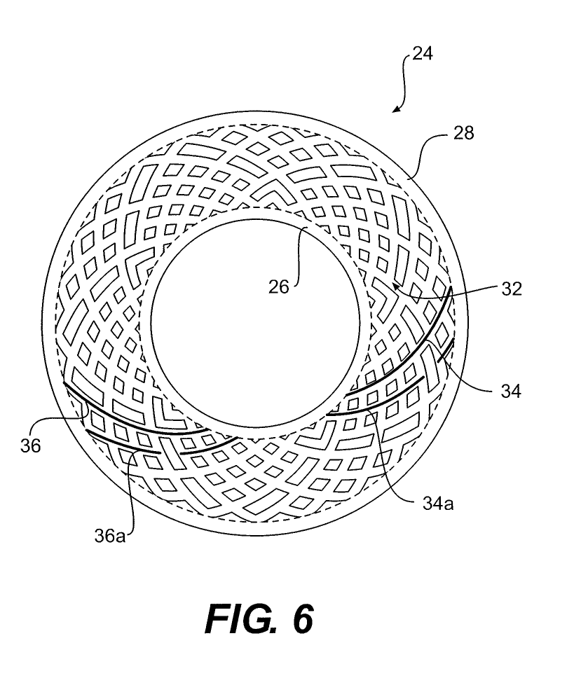

As shown in FIG. 6, some embodiments of tire 24 include first ribs 34 and/or second ribs 36 that do not extend in a continuous manner from inner circumferential barrier 26 to outer circumferential barrier 28. For example, first rib 34a does not extend in a continuous manner from inner circumferential barrier 26 to outer circumferential barrier 28, and second rib 36a does not extend in continuous manner from inner circumferential barrier 26 to outer circumferential barrier 28. As shown in FIG. 6, exemplary tire 24 also includes first ribs 34 and second ribs 36 that extend in a continuous manner from inner circumferential barrier 26 to outer circumferential barrier 28. Such an exemplary configuration may serve to reduce the weight of tire 24 while maintaining a desired level of cushioning and/or support.

According to some embodiments, tire 24 may be formed from an elastically deformable material, such as, for example, polyurethane, natural rubber, and/or synthetic rubber. For example, one or more of inner circumferential barrier 26, outer circumferential barrier 28, tread portion 30, and support structure 32 may be formed from polyurethane, natural and/or synthetic rubber, or combinations thereof. According to some embodiments, different parts of tire 24 may be formed from different materials. For example, support structure 32 may be formed from a first material, and tread portion 30 may be formed from a second material. For such embodiments, support structure 32 and/or other parts of tire 24 may be formed separately from tread portion 30, and tread portion 30 may be coupled or joined to outer circumferential barrier 28 via known methods, such as, for example, mechanical fastening and/or adhesives. According to some embodiments, inner circumferential barrier 26, support structure 32, outer circumferential barrier 28, and tread portion 32 may be formed together as a single piece, for example, via molding. According to some embodiments, inner circumferential barrier 26, support structure 32, outer circumferential barrier 28, and tread portion 32 may be formed together as a single piece, and support structure 32 and/or outer circumferential barrier 28 may be formed from a first material, and tread portion 30 may be formed from a second material different from the first material, such that tread portion 30 exhibits different characteristics than support structure 30 and/or outer circumferential barrier 28. For example, the second material forming tread portion 30 may provide tread portion 30 with more wear resistance, abrasion resistance, hardness, toughness, and/or a different appearance (e.g., color or texture) than the first material forming inner circumferential barrier 26, support structure 32 and/or outer circumferential barrier 28. According to some embodiments, the first material may include at least one polymer selected from the group consisting of polyurethane, natural rubber, synthetic rubber, and combinations thereof. According to some embodiments, the second material may include at least one polymer selected from the group consisting of polyurethane, natural rubber, synthetic rubber, and combinations thereof

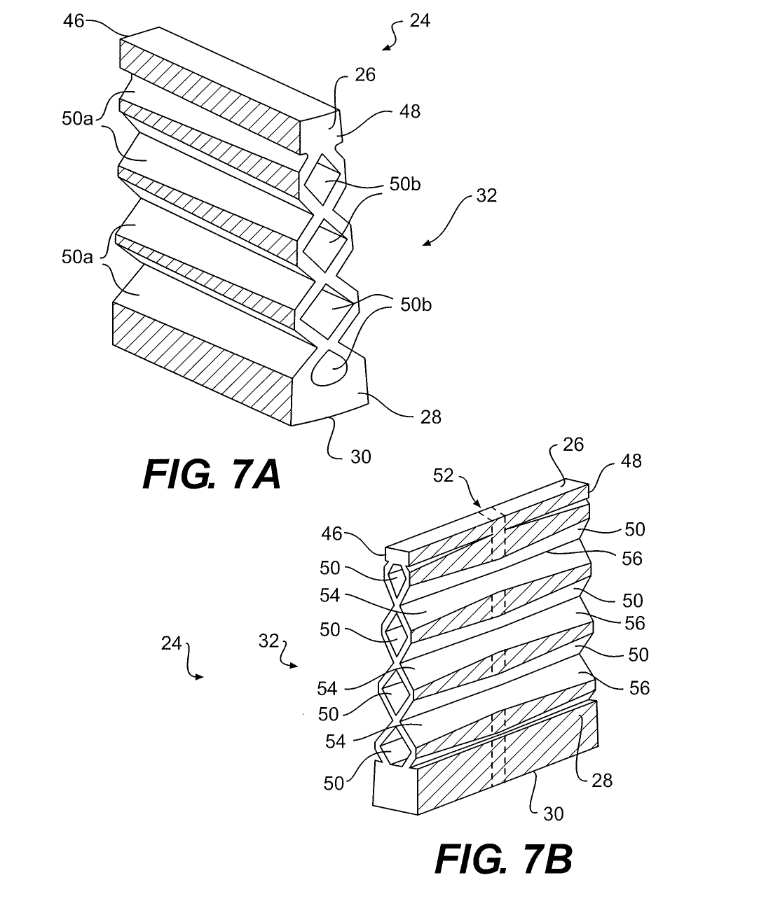

Exemplary support structure 32 shown in FIG. 7A defines a first axial side 46 and a second axial side 48 of tire 24. According to some embodiments, first ribs 34 and second ribs 36 define a plurality of cavities 50 extending between first axial side 46 and second axial side 48 (see FIGS. 7A-10B). According to some embodiments, at least some of cavities 50 may each extend in an uninterrupted manner from first axial side 46 to second axial side 48. For some embodiments, at least some of cavities 50 may each define a cross-section perpendicular to the axis X that remains substantially uniform in area and/or shape as each of cavities 50 extends from first axial side 46 to second axial side 48. According to some embodiments, at least some of cavities 50 may each be partially or fully interrupted at a point between first axial side 46 and second axial side 48.

According to some embodiments, at least some of cavities 50 may be at least partially filled with a material configured to alter one or more characteristics of tire 24. For example, at least some of cavities 50 may be at least partially filled with a material configured to adjust the level of cushioning of tire 24 (e.g., to increase the stiffness of support structure 32), to prevent support structure 32 from collapsing, and/or to prevent undesirable external objects from entering cavities 50. Such materials may include, for example, one or more of elastomeric materials, polyurethane, natural rubber, synthetic rubber, polymers, foams, plastics, and metals.

According to some embodiments, at least some of cavities 50 may each define an axial cross-section perpendicular to the axis X that varies between first axial side 46 and second axial side 48 of tire 24, for example, as shown in FIGS. 7A-10B. For example, the area and/or shape of the axial cross-section of each of the at least some cavities 50 at at least one location or point along the axial direction of tire 24 may differ from the area and/or shape of the axial cross-section of the same cavity at a different location or point along the axial direction of tire 24.

For example, FIG. 7A shows a partial section view of an exemplary support structure 32 with first ribs 34 and second ribs 36 defining exemplary cavities 50 that have a cross-section perpendicular to the axis X of tire 24 that varies as each of cavities 50 extends from first axial side 46 of tire 24 to second axial side 48 of tire 24. In particular, FIG. 7A shows a sector of tire 24 sliced in a direction parallel to the axis X, so that the cross-sections of cavities 50 are viewable. As shown in FIG. 7A, exemplary cavities 50a are tapered as they extend from first axial side 46 to second axial side 48 of tire 24. (FIG. 7A shows half of cavities 50a.) As shown in FIG. 7A, exemplary cavities 50a maintain the same shape as they extend from first axial side 46 to second axial side 48, but the area of the cross-section is reduced as cavities 50a extend from first axial side 46 to second axial side 48. According to some embodiments, support structure 32 of tire 24 may be formed via a mold, and forming cavities 50 such that they are tapered may render it relatively easier to release the molded tire from the mold.

For example, tire 24, including inner circumferential barrier 26, outer circumferential barrier 28, tread portion 30, and support structure 32, may be formed as a single, monolithic piece, for example, via molding. According to some embodiments, however, it is also contemplated that one or more of inner circumferential barrier 26, outer circumferential barrier 28, tread portion 30, and support structure 32 may be formed separately and thereafter coupled to other portions of tire 24 via adhesives and/or mechanical methods (e.g., via fasteners and/or complementary portions on adjacent parts.) For example, inner circumferential barrier 26, outer circumferential barrier 28, and support structure 32 may be formed as a single, monolithic piece via molding, and tread portion 30 may be coupled to the monolithic piece via adhesives and/or mechanical methods, or may be molded onto outer circumferential barrier 28 in a separate molding operation.

According to some embodiments, the axial cross-section of a first plurality of at least some of cavities 50 defines an area that decreases as the first plurality of cavities 50 extends from first axial side 46 toward second axial side 48, and the axial cross-section of a second plurality of the at least some of cavities 50 defines an area that decreases as the second plurality of the least some cavities 50 extends from second axial side 48 toward first axial side 46. For example, as shown in FIG. 7A, the area of the cross-sections of cavities 50a decreases as they extend from first axial side 46 to second axial side 48, and the area of the cross-section of cavities 50b decreases as cavities 50b extend from second axial side 48 to first axial side 46. According to the exemplary embodiment shown in FIG. 7A, each of cavities 50a of the first plurality of cavities may be located adjacent at least one of cavities 50b of the second plurality of cavities. According to some embodiments, support structure 32 of tire 24 may be formed via a mold including two opposing mold halves, with each of the two mold halves having tapered projections configured to provide tapered cavities 50a and 50b. Such an exemplary configuration may render it relatively easier to release the molded tire from the mold halves.

FIG. 7B shows another exemplary embodiment of tire 24 having cavities 50 in which the cross-section of the cavities varies between first axial side 46 and second axial side 48 of tire 24. As shown in FIG. 7B, exemplary support structure 32 has an axially intermediate region 52 between first axial side 46 and second axial side 48 of tire 24. For example, intermediate region 52 may include a portion of support structure 32 substantially equidistant between first axial side 46 and second axial side 48. According to the exemplary embodiment shown, at least some of cavities 50 include a first portion 54 defining an axial cross-section having an area that decreases as first portion 54 extends from first axial side 46 toward intermediate region 52. The at least some cavities 50 may also include a second portion 56 that defines an axial cross-section having an area that decreases as second portion 56 extends from second axial side 48 toward intermediate region 52. As shown in FIG. 7B, first portions 54 and second portions 56 are tapered. According to some embodiments, support structure 32 of tire 24 may be formed via a mold including two opposing mold halves, with each of the two mold halves having tapered projections configured to extend toward one another and provide tapered first and second portions 54 and 56. Such an exemplary configuration may render it relatively easier to release the molded tire from the mold halves.

According to some embodiments, intermediate region 52 may include a length in the axial direction that has substantially the same cross-section. Alternatively, intermediate region 52 may have a cross-section that follows tapered cross-sections of first and second portions 54 and 56 and includes the point of transition between first and second portions 54 and 56 (i.e., the point at which tapered cross-sections of first and second portions 54 and 56 meet).

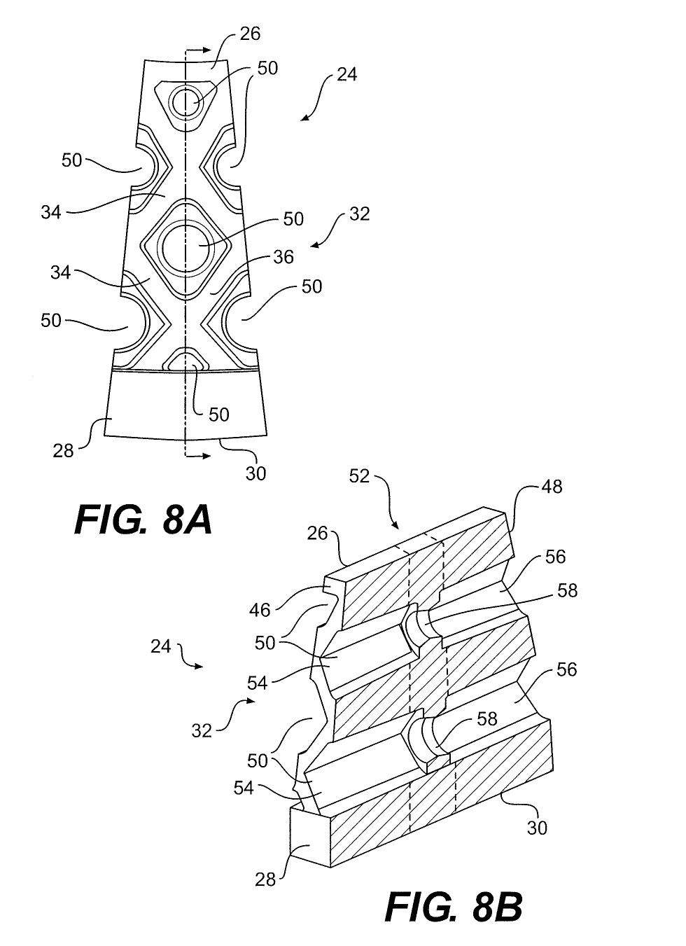

According to some embodiments, first portion 54 and second portion 56 of cavities 50 are separated from one another by a third portion 58 of cavities 50, wherein third portion 58 has an axial cross-section having an area smaller than the respective areas of the axial cross-sections of first portion 54 and second portion 56. For example, as shown in FIGS. 8A and 8B, third portion 58 is located axially at intermediate region 52 and separates first portion 54 from second portion 56. Exemplary first portions 54 of cavities 50 have an axial cross-section having an area that decreases as first portions 54 extend from first axial side 46 toward third portion 58. The shape of the axial cross-section of first portion 54 remains substantially unchanged. Similarly, exemplary second portions 56 have an axial cross-section having an area that decreases as second portions 56 extend from second axial side 48 toward third portion 58, and the shape of the axial cross-section of second portion 56 remains substantially unchanged. In contrast, according to some embodiments, third portion 58 has an axial cross-section having a shape different from the shape of the respective axial cross-sections of first and second portions 54 and 56. In the example shown, the respective axial cross-sections of first and second portions 54 and 56 have substantially parallel opposite sides (e.g., they are approximate parallelograms), and the axial cross-section of third portion 58 is substantially circular or elliptical. According to some embodiments, first and second portions 54 and 56 will be mirror images of one another. At least some of the “corners” between opposite sides of the axial cross-sections of portions 54 and 56 may be rounded or they may be angular (i.e., they have “sharp corners”).

Exemplary configurations including a third portion 58 may provide first and second ribs 34 and 36 with additional support that prevents or reduces the likelihood that cavities 50 will collapse under load. This, in turn, will prevent the sides of first and second ribs 34 and 36 forming first and second portions 54 and 56 of cavities 50 from contacting one another, thereby preventing potential damage to first and second ribs 34 and 36.

According to some embodiments, support structure 32 of tire 24 may be formed via a mold including two opposing mold halves, with each of the two mold halves having tapered projections corresponding to the axial cross-sections and configured to extend toward one another. The projections provide tapered first and second portions 54 and 56, and the circular or elliptical third portion 58. Such an exemplary configuration may render it relatively easier to release a molded tire from the mold halves.

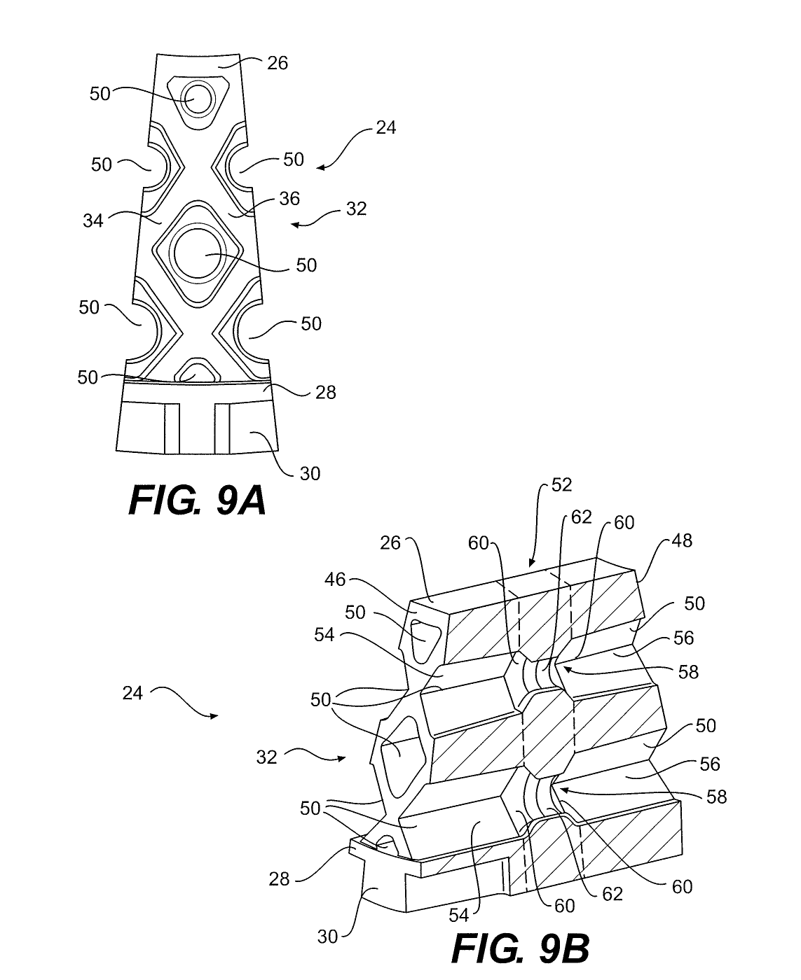

As shown in FIGS. 9A and 9B, some embodiments include at least some cavities 50 having a cross-section including a transition portion 60 between first portion 54 and third portion 58 and/or between second portion 56 and third portion 58. For example, similar to the exemplary embodiment shown in FIGS. 8A and 8B, first portion 54 and second portion 56 are separated from one another by third portion 58 of cavities 50, wherein third portion 58 has an axial cross-section having an area smaller than the respective areas of the axial cross-sections of first portion 54 and second portion 56. Third portion 58 is located axially at intermediate region 52 and separates first portion 54 from second portion 56, and first portion 54 of each cavity 50 has an axial cross-section having an area that decreases as first portion 54 extends from first axial side 46 toward third portion 58. The shape of the axial cross-section of first portion 54 remains substantially unchanged. Similarly, exemplary second portion 56 has an axial cross-section having an area that decreases as second portion 56 extends from second axial side 48 toward third portion 58, and the shape of the axial cross-section of second portion 56 remains substantially unchanged.

According to the exemplary embodiment shown in FIGS. 9A and 9B, third portion 58 includes a pair of transition portions 60 each joining first and second portions 54 and 56 to a central portion 62 of third portion 58. Transition portions 60 provide a transition zone between the axial cross-sections of first and second portions 54 and 56 and the axial cross-section of central portion 62 of third portion 58.

In particular, in the exemplary embodiment shown in FIGS. 9A and 9B, central portion 62 of third portion 58 has an axial cross-section having a shape different from the shape of at least the majority of the respective axial cross-sections of first and second portions 54 and 56. For example, the respective axial cross-sections of first and second portions 54 and 56 are substantially parallelograms, and the axial cross-section of central portion 62 is substantially circular or elliptical. Each of transition portions 60 extends from an axial cross-section end having a generally parallelogram-like shape to an opposite axial cross-section end having a circular or elliptical shape, thereby providing a transition zone between each of the axial cross-sections of first and second portions 54 and 56 and the axial cross-section of central portion 62 of third portion 58. Similar to the exemplary embodiment shown in FIGS. 8A and 8B, support structure 32 of tire 24 shown in FIGS. 9A and 9B may be formed via a mold including two opposing mold halves, with each of the two mold halves having tapered projections corresponding to the axial cross-sections and configured to extend toward one another. The projections provide tapered first and second portions 54 and 56 and the circular or elliptical third portion 58, with transition portions 60. Such an exemplary configuration may render it relatively easier to release the molded tire from the mold halves.

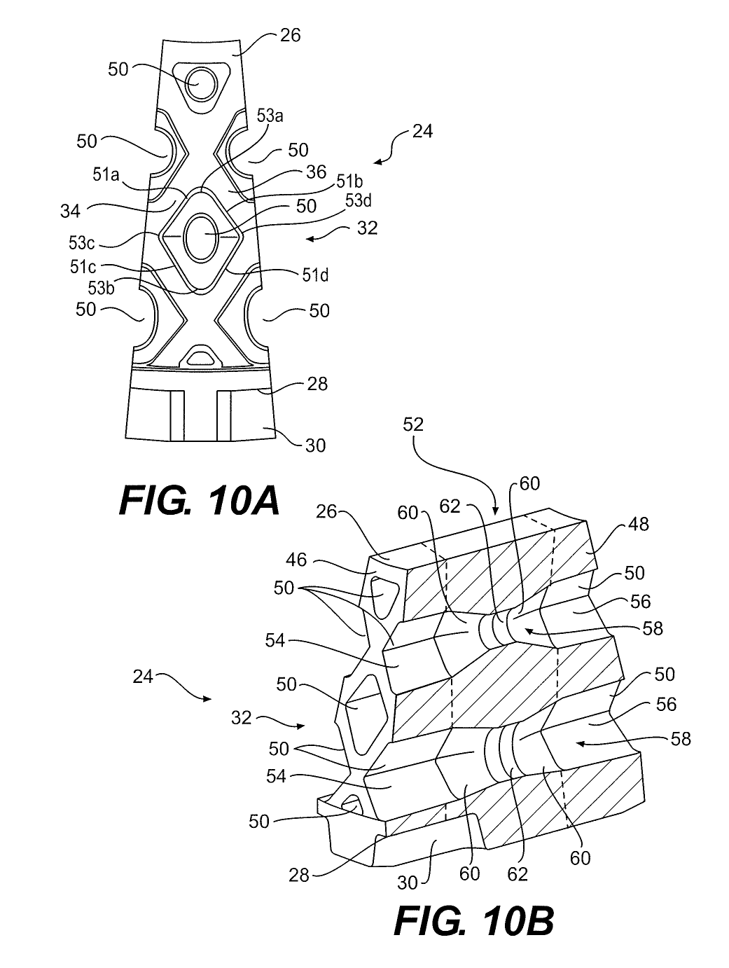

The exemplary embodiment shown in FIGS. 10A and 10B is similar to the embodiment shown in FIGS. 9A and 9B, except that transition portions 60 are relatively longer in the axial direction than the transition portions 60 of the embodiment shown in FIGS. 9A and 9B. This may further facilitate releasing the molded tire from the mold halves during manufacturing.

According to some embodiments, for example, as shown in FIGS. 10A and 10B, at least some of cavities 50 may have a cross-section having opposite sides that are substantially parallel to one another. For example, the exemplary embodiment shown in FIGS. 10A and 10B includes cavities 50 having a cross-section including four sides 51a, 51b, 51c, and 51d, with sides 51a and 51d being substantially parallel to one another and sides 51b and 51c being substantially parallel to one another. In the example shown, sides 51a and 51b are coupled to one another via a relatively rounded or curved corner 53a, and sides 51c and 51d are coupled to one another via a relatively rounded or curved corner 53b. Sides 51a and 51c are coupled to one another via a relatively sharp or creased corner 53c, and sides 51b and 51d are coupled to one another via relatively sharp or creased corner 53d. According some embodiments, the radial distance between corners 53a and 53b is greater than or equal to the circumferential distance between corners 53c and 53d. Such a configuration may serve to prevent or avoid contact between the interior faces of cavities 50 when tire 24 is subjected to a wide variation in loads or shocks.

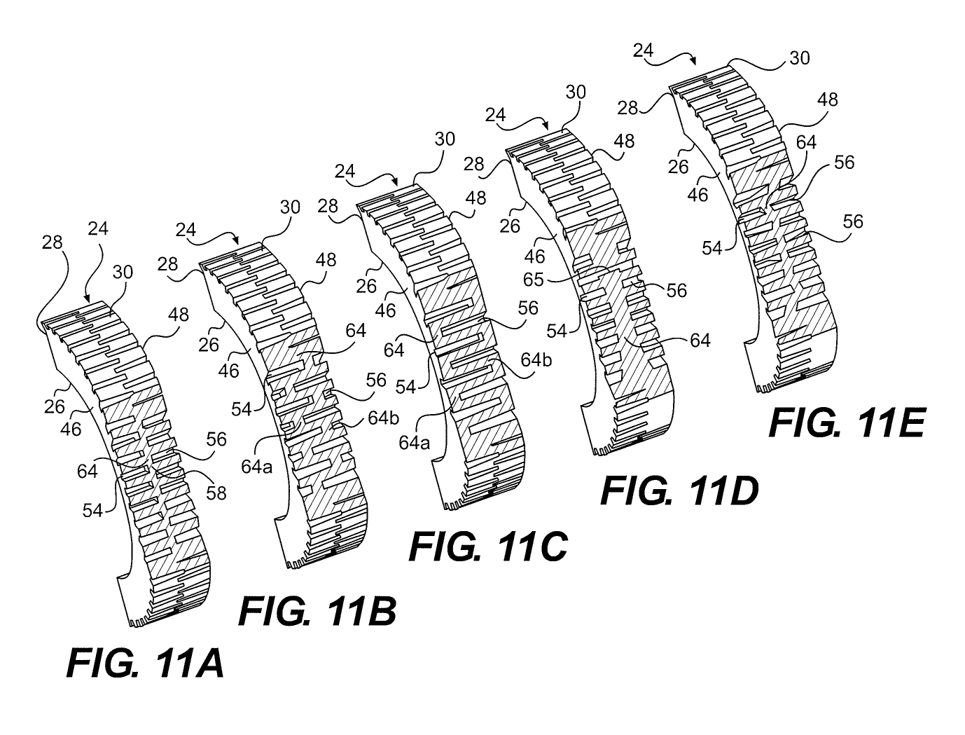

According to some embodiments, for example, as shown in FIGS. 11A-11E, third portion 58 may form a web 64 that forms a barrier in cavities 50, for example, such that first and second portions 54 and 56 of cavities 50 are separated from one another by web 64. For example, as shown in FIG. 11A, web 64 forms a radial cross-section that extends circumferentially about inner circumferential barrier 26 and at least partially between inner circumferential barrier 26 and outer circumferential barrier 28, such that web 64 intersects at least some of first ribs 34 and second ribs 36. In the exemplary embodiment shown in FIG. 11A, web 64 is perpendicular to inner circumferential barrier 26 and outer circumferential barrier 28, and is equidistant between first and second axial sides 46 and 48 of tire 24. According to some embodiments, web 64 is not perpendicular to inner circumferential barrier 26 and outer circumferential barrier 28.

As shown in FIG. 11B, web 64 may be located to closer to first axial side 46 than second axial side 48 in at least some locations. In addition, as shown in FIGS. 11B and 11C, web 64 may alternate between being closer to first axial side 46 and second axial side 48, as web 64 extends between first and second rib pairs 34 and 36. For the embodiment shown in FIG. 11B, first portions 64a of web 64 are closer to, but spaced from, first axial side 46, and second portions 64b are closer to, but spaced from, second axial side 48. As shown in FIG. 11C, first portions 64a of web 64 are coextensive with first axial side 46, and second portions 64b are coextensive with second axial side 48. As shown in FIG. 11D, some embodiments may include a web 64 having a non-uniform thickness, for example, a thickness that increases as web 64 extends from inner circumferential barrier 26 toward outer circumferential barrier 28. According to some embodiments, web 64 may include one or more passages 65 providing flow communication between first and second portions 54 and 56 of cavities 50. According to some embodiments, web 64 may have a cross-section that forms a curved third rib portion, for example, as shown in FIG. 11E.

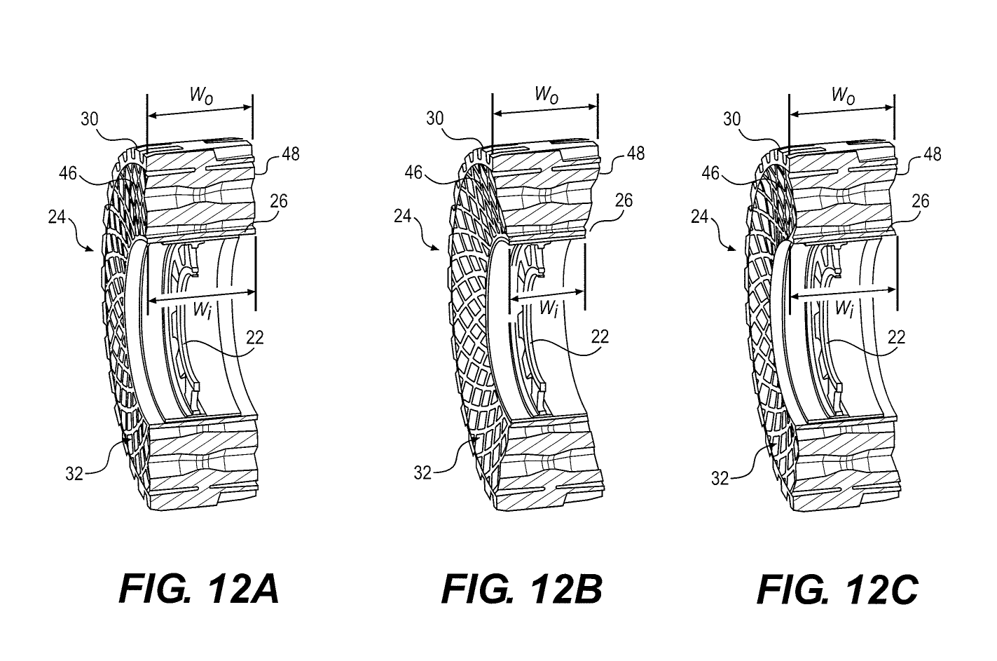

Referring to FIGS. 12A-12C, exemplary support structure 32 at least partially defines first axial side 46 and second axial side 48 of tire 24, and first and second axial sides 46 and 48 define an axial width of support structure 32, with the axial width being parallel to the axis X of tire 24 (see FIG. 2A). As shown in FIG. 12A, some embodiments of tire 24 are configured such that the axial width of support structure 32 remains substantially constant as support structure 32 extends between inner circumferential barrier 26 and outer circumferential barrier 28. In such embodiments, first axial side 46 and second axial side 48 are substantially parallel to one another.

As shown in FIGS. 12B and 12C, some embodiments of tire 24 are configured such that the axial width of support structure 32 varies as support structure 32 extends between inner circumferential barrier 26 and outer circumferential barrier 28. For example, as shown in FIG. 12B, support structure 32 has an inner axial width Wᵢ associated with inner circumferential barrier 26 (e.g., adjacent inner circumferential barrier 26) and an outer axial width Wₒ associated with outer circumferential barrier 28 (e.g., adjacent outer circumferential barrier 28), where the outer axial width Wₒ is greater than the inner axial width Wᵢ. For example, the ratio of the outer axial width Wₒ to the inner axial width Wᵢ may range from 1:1 to 3.5:1. In some embodiments, the ratio of the outer axial width Wₒ to the inner axial width Wᵢ may range from 1.2:1 to 3.5:1, for example, from 1.4:1 to 2.8:1. In the example shown in FIG. 12B, the radial cross-section of support structure 32 between inner circumferential barrier 26 and outer circumferential barrier 28 defines a trapezoid. Although the trapezoidal cross-section shown in FIG. 12B has substantially straight opposing axial sides, it is contemplated that the opposing axial sides may be curved (e.g., they may be convex). According to some embodiments, the inner axial width Wᵢ and the outer axial width Wₒ may be configured such that the outer axial width Wₒ is less than the inner axial width Wᵢ.

Some embodiments of tire 24 may be configured such that support structure 32 has an axial width W that is at a minimum at a radial point between inner circumferential barrier 26 and outer circumferential barrier 28. For example, FIG. 12C shows an exemplary embodiment having first and second axial sides 46 and 48 defining respective first and second sidewalls of tire 24, and at least one of the first and second sidewalls is concave as support structure 32 extends between inner circumferential barrier 26 and outer circumferential barrier 28. In the exemplary embodiment shown in FIG. 12C, both sidewalls are concave. Such a configuration may serve to reduce the weight of tire 24. According to some embodiments, one or both of the sidewalls may be convex, such that support structure 32 has an axial width W that is at a maximum at a radial point between inner circumferential barrier 26 and outer circumferential barrier 28. According to some embodiments, the sidewalls may be any combination of convex, concave, and straight.

According to some embodiments, first and/or second ribs 34 and 36 may not extend completely from first axial side 46 to second axial side 48 of tire 24. For example, at least some of first ribs 34 may extend from first axial side 46 of support structure 32, and at least some of second ribs 36 may extend from second axial side 48 of tire 24, wherein the at least some first ribs 34 extend partially, but not completely, from first axial side 46 toward second axial side 48, such that at least some of first ribs 34 terminate prior to reaching second axial side 48. Such an exemplary configuration may result in tire 24 having different cushioning characteristic at different locations across its axial width.

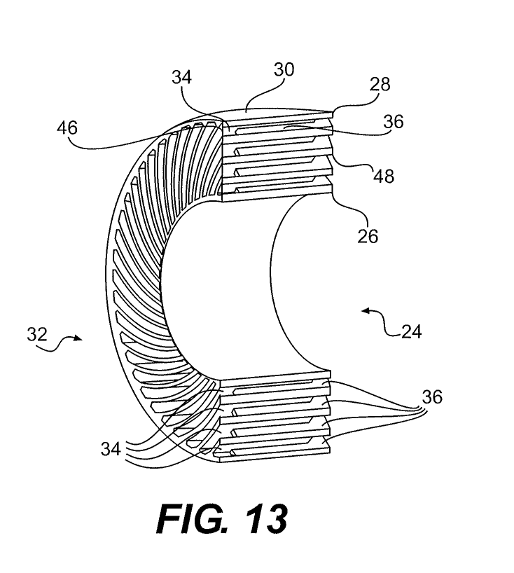

Similarly, according to some embodiments, at least some of second ribs 36 may extend from second axial side 48 of support structure 32, wherein the at least some second ribs 36 extend partially, but not completely, from second axial side 48 toward first axial side 46, such that at least some of second ribs 36 terminate prior to reaching first axial side 46. For example, the exemplary embodiment shown in FIG. 13 includes first ribs 34 that extend from axial first side 46 to second axial side 48, while second ribs 36 extend from second axial side 48 and terminate at an axial extent prior to reaching first axial side 46.

According to some embodiments, at least some first ribs 34 may terminate at a first axial extent, and at least some second ribs 48 may terminate at a second axial extent. According to some embodiments, the first axial extent is closer to second axial side 48 of tire 24 than first axial side 48, and the second axial extent is closer to first axial side 46 than second axial side 48, such that at least some first ribs 34 overlap axially with at least some second ribs 36. According to some embodiments, the first axial extent and the second axial extent are located at a common axial position with respect to first and second axial sides 46 and 48 of tire 24. According to some embodiments, the first axial extent and the second axial extent are located at a common axial position with respect to first and second axial sides 46 and 48 of tire 24, and the common axial position is located at an axially central region of tire 24 (e.g., at an axial location equidistant from first axial side 46 and second axial side 48). According to some embodiments, at least some first ribs 34 terminate at the first axial extent, at least some second ribs 48 terminate at the second axial extent, the first axial extent is closer to first axial side 46 of tire 24 than second axial side 48, and the second axial extent is closer to second axial side 48 than first axial side 46, such that an axially central region of tire 24 does not include first ribs 34 or second ribs 36.

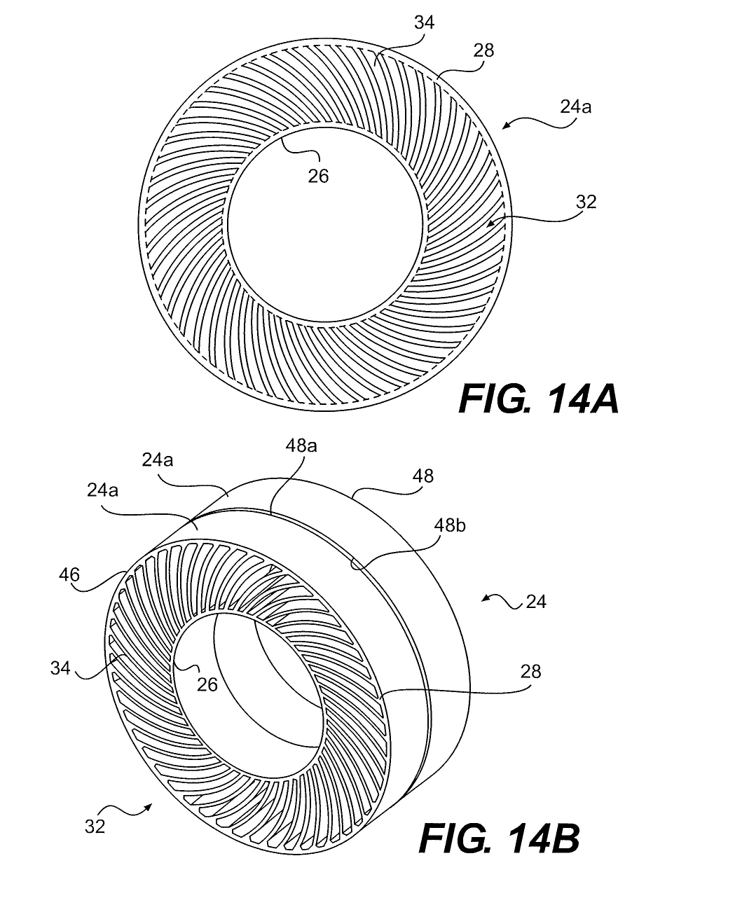

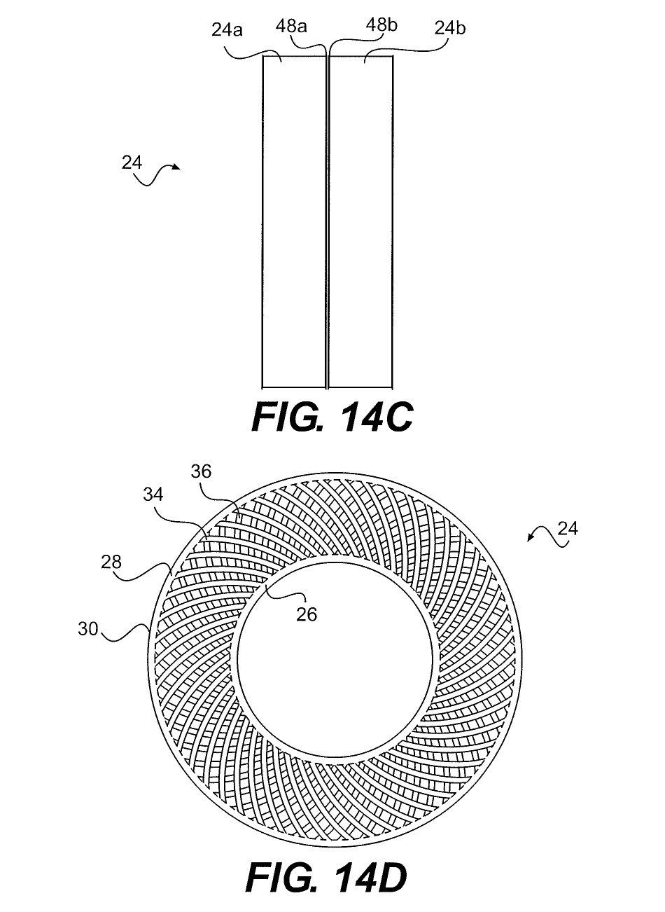

According to some embodiments, tire 24 may be a composite formed from two tire portions (e.g., annular halves) joined to one another at an axial location between first axial side 46 and second axial side 48 of tire 24 formed in this manner. For example, as shown in FIGS. 14A-14D, exemplary tire 24 includes a first tire portion 24a coupled to a second tire portion 24b. First tire portion 24a includes first ribs 34, and second tire portion 24b includes second ribs 36, and tire portions 24a and 24b form tire 24 by being coupled to one another in a side-by-side relationship, so that second axial side 48a of first tire portion 24a is located adjacent second axial side 48b of second tire portion 24b. In this exemplary configuration, first ribs 34 extend in a first circumferential direction of tire 24, and second ribs 36 extend in a second, opposite circumferential direction of tire 24. According to some embodiments, first ribs 34 and second ribs 36 may intersect one another and share common material at the points of intersection. According to some embodiments, first and second tire portions 24a and 24b may be coupled to one another via adhesives and/or mechanical fastening. According to some embodiments, first and second tire portions 24a and 24b may be coupled to one another by forming first and second tire portions 24a and 24b together via, for example, molding.

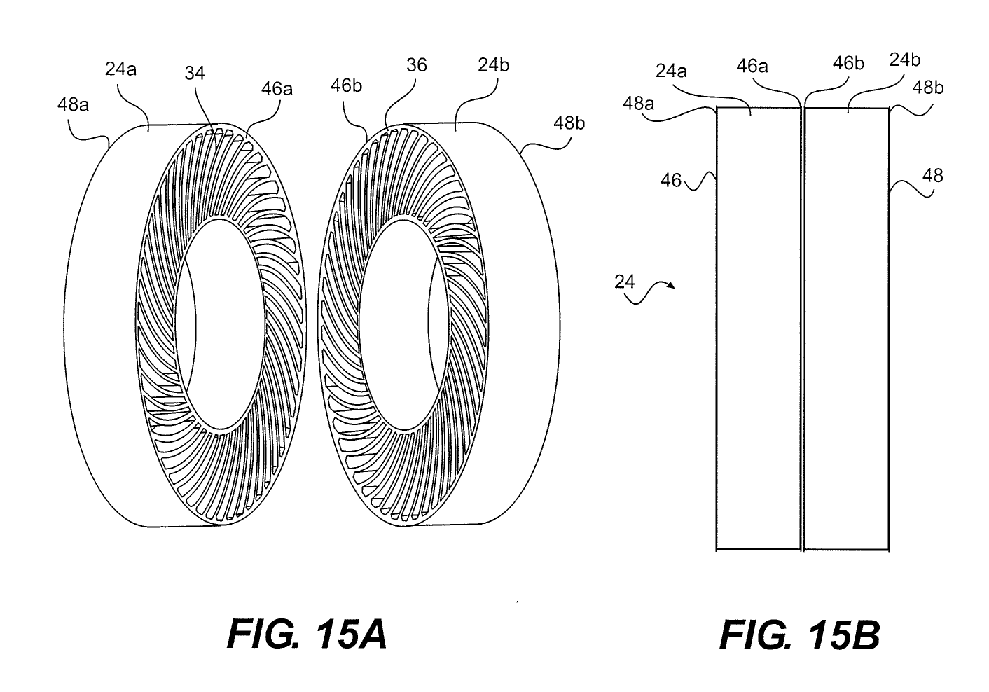

According to some embodiments, first and/or second tire portions 24a and 24b may each include both first ribs 34 and second ribs 36. For example, one or both of first and second tire portions 24a and 24b may be configured such that first and/or second ribs 34 and 36 do not extend completely from first axial side 46 to second axial side 48 of the respective tire portion(s), for example, as described previously herein. For example, as shown in FIGS. 15A and 15B, first and second tire portions 24a and 24b are configured such that respective second ribs 36a and 36b of tire portions 24a and 24b do not extend completely from respective second axial sides 48a and 48b to respective first axial sides 46a and 46b. Such configurations may provide the ability to tailor the rib density at various locations along the axial width W of tire 24 to meet desired performance characteristics.

According to some embodiments, first and second tire portions 24a and 24b may be coupled to one another such that first axial side 46a of first tire portion 24a is adjacent first axial side 46b of second tire portion 24b (see FIGS. 15A and 15B), such that second ribs 36a and 36b are not present at the axial location of tire 24 corresponding to the interface between first tire portion 24a and second tire portion 24b. According to some embodiments, first and second tire portions 24a and 24b may be coupled to one another such that second axial side 48a of first tire portion 24a is adjacent second axial side 48b of second tire portion 24b, such that second ribs 36a and 36b are not present at the opposite, outer axial edges of tire 24. These various configurations may be tailored to provide the desired cushioning characteristics of the resulting tire 24.

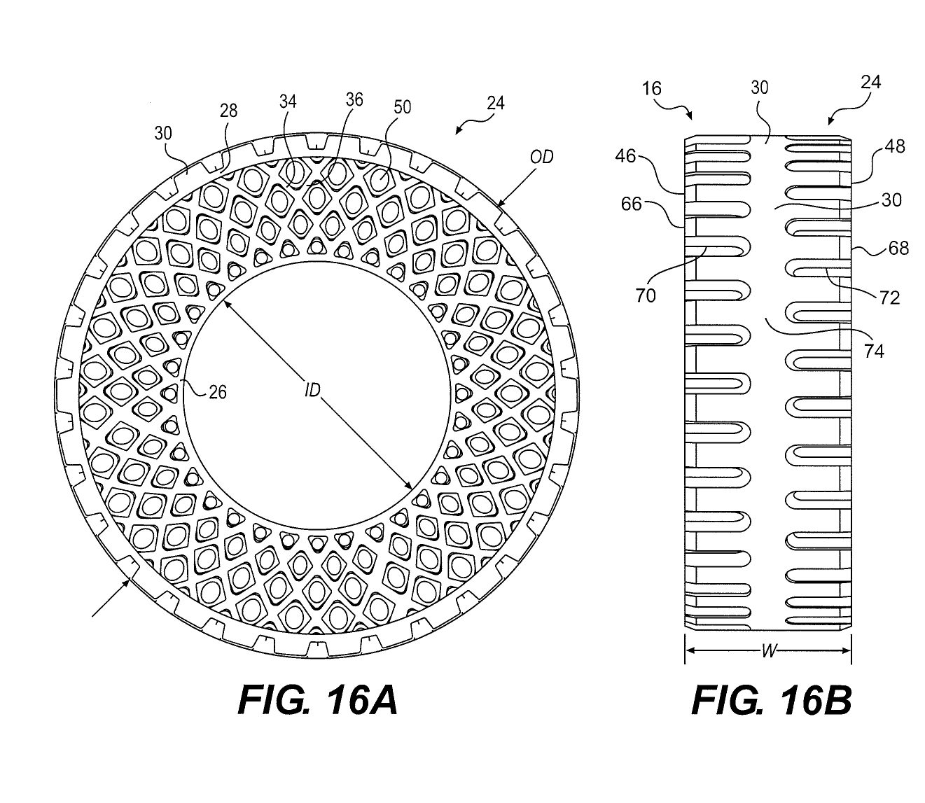

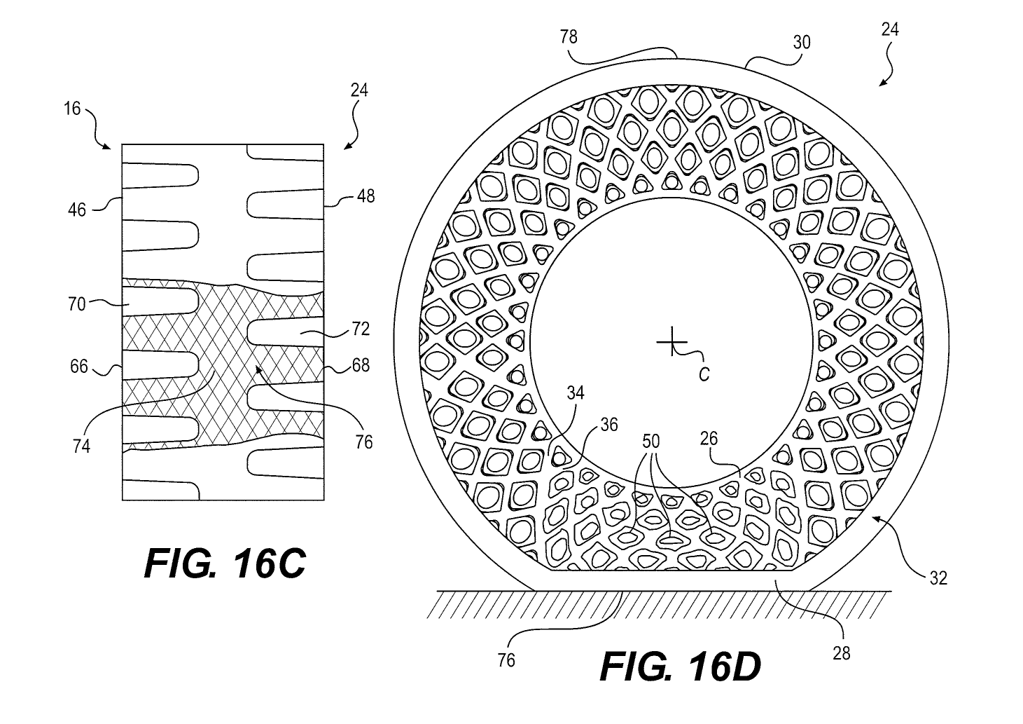

FIGS. 16A-16D show an exemplary embodiment of a tire 24 configured to be coupled to or mounted on a hub 22 (see, e.g., FIG. 1) to form a wheel 16. Exemplary tire 24 includes an inner circumferential barrier 26, an outer circumferential barrier 28, a tread portion 30, and a support structure 32 extending between inner circumferential barrier 26 and outer circumferential barrier 28. Exemplary support structure 32 includes first and second ribs 34 and 36 formed, for example, according to the exemplary embodiment shown in FIGS. 10A and 10B, such that cavities 50 include a first portion 54, a second portion 56, a pair of transition portions 60, and a central portion 62. Exemplary support structure 32 has first and second axial sides 46 and 48 that may be substantially parallel to one another or may form a trapezoidal cross-section, for example, as shown in FIG. 12B.

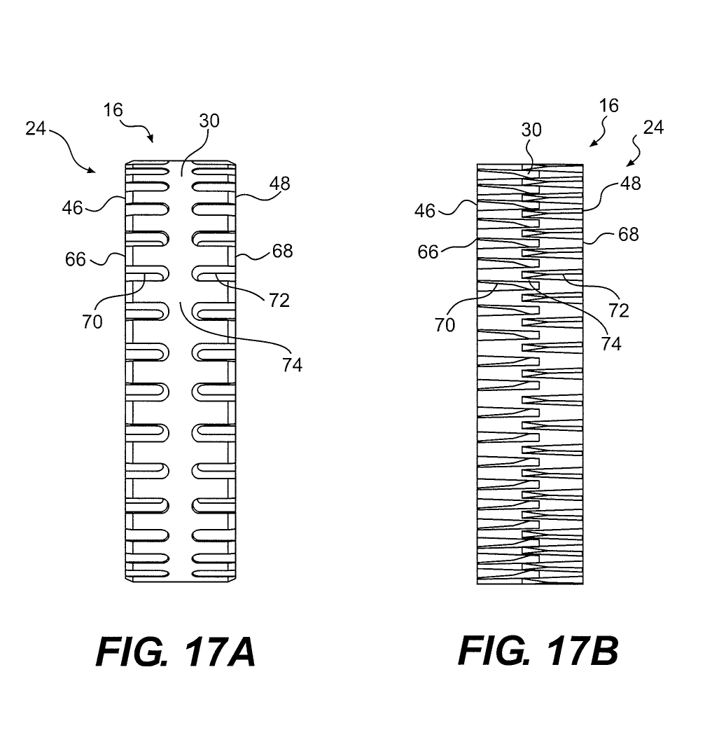

As shown in FIG. 16B, exemplary tire 24 includes tread portion 30 having a first edge 66 and an opposite second edge 68. Exemplary tread portion 30 includes a plurality of circumferentially spaced, transverse first grooves 70 associated with first edge 66, a plurality of circumferentially spaced, transverse second grooves 72 associated with second edge 68, and a circumferential tread rib 74 separating first grooves 70 and second grooves 72 from one another. In the example shown in FIG. 16B, first and second grooves 70 and 72 extend perpendicularly from the respective first and second edges 66 and 68. According to some embodiments, at least some of first and/or second grooves 70 and 72 extend obliquely with respect to first and second edges 66 and 68. In the example shown in FIG. 16B, first and second grooves 70 and 72 are circumferentially offset with respect to one another. As shown in FIG. 17A, according to some embodiments, first and second grooves 70 and 72 are circumferentially aligned with one another.

FIG. 16C shows an exemplary contact patch 76 formed by exemplary tread portion 30 shown in FIG. 16B. Exemplary contact patch 76 may provide a relatively larger contact area, thereby resulting in a lower ground pressure for tire 24, relative to a tire having a different tread design, for example, the tread design shown in FIG. 17B.

FIG. 16D shows a side view of the exemplary embodiment of tire 24 shown in FIGS. 16A-16C when loaded. As shown in FIG. 16D, when tire 24 is subjected to a load, support structure 32 cushions the load by permitting compression of support structure 32, so that inner and outer circumferential barriers 26 and 28 are closer together on the side of tire 24 adjacent contact patch 76. This results in deformation, but not collapse, of cavities 50 of support structure 32. By virtue of the configuration of support structure 32, first ribs 34 and second ribs 36 support one another in compression, such that cavities 50 do not collapse and cause inner faces of opposite sides of cavities 50 to contact one another. Contact between inner faces of cavities 50 may result in accelerating wear and/or damage to tire 24, and thus, preventing contact between inner faces of cavities 50 may result in increasing the service life of tire 24. In addition, in the exemplary embodiment shown, a tread portion 78 opposite contact patch 76 remains substantially the same distance from the center C of tire 24, regardless of the load on tire 24 and/or the deformation of support structure 32 adjacent contact patch 76. This contrasts with some tension wheels, in which the distance between an upper surface of the wheel and the center of the wheel increases when the wheel is loaded.

According to some embodiments of tread portion 30, at least some of first grooves 70 terminate at a first axial transverse point of tread portion 30, and at least some of second grooves 72 terminate at a second axial transverse point of tread portion 30. According to the examples shown in FIGS. 16B and 17A, the first axial transverse point is closer to first edge 66 than second edge 68, and the second axial transverse point is closer to second edge 68 than first edge 66. As shown in FIG. 17B, according to some embodiments, the first axial transverse point is closer to second edge 68 than first edge 66, and the second axial transverse point is closer to first edge 66 than second edge 68. For example, a median point of tread portion 30 is located equidistant between first and second edges 66 and 68, and the first axial transverse point is located between the median point and second edge 68, and the second axial transverse point is located between the median point and first edge 66. Other tread pattern designs are contemplated.

Tire 24 may have dimensions tailored to the desired performance characteristics based on the expected use of the tire. For example, referring to FIGS. 16A-16D, exemplary tire 24 may have a width W at tread portion 30 ranging from 0.1 meter to 2 meters (e.g., 1 meter), an inner diameter ID for coupling with hub 22 ranging from 0.5 meter to 4 meters (e.g., 2 meters), and an outer diameter OD ranging from 0.75 meter to 6 meters (e.g., 4 meters). According to some embodiments, the ratio of the inner diameter of tire 24 to the outer diameter of tire 24 ranges from 0.25:1 to 0.75:1, or 0.4:1 to 0.6:1, for example, about 0.5:1. Referring to FIGS. 12A-12C, support structure 32 may have an inner axial width Wᵢ at inner circumferential barrier 26 ranging from 0.05 meter to 3 meters (e.g., 0.8 meters), and an outer axial width Wₒ at outer circumferential barrier 28 ranging from 0.1 meter to 2 meters (e.g., 1 meter). For example, exemplary tire 24 shown in FIGS. 16A-16D may have a cross-section similar to the cross-section shown in FIG. 12B. Other dimensions are contemplated. For example, for smaller machines, correspondingly smaller dimensions are contemplated.

### INDUSTRIAL APPLICABILITY

The non-pneumatic tires disclosed herein may be used with any machines, including self-propelled vehicles or vehicles intended to be pushed or pulled by another machine. According to some embodiments, the non-pneumatic tires disclosed herein may overcome or mitigate potential drawbacks associated with pneumatic tires and prior non-pneumatic tires.

For example, the non-pneumatic tires disclosed herein may be relatively more reliable than pneumatic tires because they do not necessarily retain air under pressure. Thus, at least some embodiments of the disclosed non-pneumatic tires, unlike pneumatic tires, will not deflate due to punctures or air leaks. Moreover, at least some embodiments of the tires disclosed herein may be less complex than pneumatic tires, which may result in reduced manufacturing costs relative pneumatic tires. In addition, due to the lower complexity, it may be relatively less expensive to create a manufacturing facility for producing at least some of the embodiments of non-pneumatic tires disclosed herein relative to pneumatic tires. For embodiments of non-pneumatic tires disclosed herein that are not formed from a substantial amount of natural rubber, such embodiments may be less susceptible to dramatic variability of production costs due to changes in the cost of natural rubber.

Relative to prior non-pneumatic tires, the non-pneumatic tires disclosed herein may be relatively lighter in weight, and may have an ability to provide a desired level of cushioning, regardless of whether the load on the tire changes significantly. This may be desirable when non-pneumatic tires are installed on machines that carry loads of widely varying magnitude. For example, the tires of a wheel loader or haul truck may be subjected to a relatively light load when not carrying a load of material, but a relatively high load when carrying a load of material. The non-pneumatic tires disclosed herein may be able to provide a desirable level of cushioning and/or traction in both conditions. In addition, the non-pneumatic tires disclosed herein may be relatively more durable due to the configuration of the support structure. The exemplary support structures disclosed herein may prevent or reduce the likelihood of the support structure collapsing when loaded, which, in turn, may increase the service life of the tire.

It will be apparent to those skilled in the art that various modifications and variations can be made to the exemplary disclosed tires, wheels, and machine. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A non-pneumatic tire comprising:
an inner circumferential barrier configured to be coupled to a hub;
an outer circumferential barrier radially spaced from the inner circumferential barrier; and
a support structure extending between the inner circumferential barrier and the outer circumferential barrier and coupling the inner circumferential barrier to the outer circumferential barrier,
wherein the support structure at least partially defines a first axial side of the tire and a second axial side of the tire opposite the first axial side of the tire, and
wherein the support structure includes:
a plurality of first ribs extending between the inner circumferential barrier and the outer circumferential barrier, and
a plurality of second ribs extending between the inner circumferential barrier and the outer circumferential barrier,
wherein at least some of the plurality of first ribs extend from the first axial side of the tire toward the second axial side of the tire,
wherein at least some of the plurality of second ribs extend from the second axial side of the tire toward the first axial side of the tire, and
wherein the at least some first ribs extend partially from the first axial side of the tire toward the second axial side of the tire, such that the at least some first ribs terminate prior to reaching the second axial side of the tire.

2. The tire of claim 1, wherein the at least some second ribs extend partially from the second axial side of the tire toward the first axial side of the tire, such that the at least some second ribs terminate prior to reaching the first axial side of the tire.

3. The tire of claim 2, wherein the at least some first ribs terminate at a first axial extent, and the at least some second ribs terminate at a second axial extent, and wherein the first axial extent is closer to the first axial side of the tire than the second axial side of the tire, and the second axial extent is closer to the second axial side of the tire than the first axial side of the tire.

4. The tire of claim 2, wherein the at least some first ribs terminate at a first axial extent, and the at least some second ribs terminate at a second axial extent, and wherein the first axial extent and the second axial extent are located at a common axial position between the first and second axial sides of the tire.

5. The tire of claim 4, wherein the common axial position is located at an axially central region of the tire.

6. The tire of claim 2, wherein the at least some first ribs terminate at a first axial extent, and the at least some second ribs terminate at a second axial extent, and wherein the first axial extent is closer to the second axial side of the tire than the first axial side of the tire, and the second axial extent is closer to the first axial side of the tire than the second axial side of the tire.

7. A non-pneumatic tire comprising:
an inner circumferential barrier configured to be coupled to a hub;
an outer circumferential barrier radially spaced from the inner circumferential barrier; and
a support structure extending between the inner circumferential barrier and the outer circumferential barrier and coupling the inner circumferential barrier to the outer circumferential barrier,
wherein the support structure includes:
a plurality of first ribs extending between the inner circumferential barrier and the outer circumferential barrier,
a plurality of second ribs extending between the inner circumferential barrier and the outer circumferential barrier, and
at least one web extending circumferentially about the inner circumferential barrier and at least partially between the inner circumferential barrier and the outer circumferential barrier, wherein the at least one web intersects at least some of the plurality of first ribs and at least some of the plurality of second ribs.

8. The tire of claim 7, wherein the support structure at least partially defines a first axial side of the tire and a second axial side of the tire opposite the first axial side of the tire,
wherein at least some of the plurality of first ribs extend from the first axial side of the tire toward the second axial side of the tire,
wherein at least some of the plurality of second ribs extend from the second axial side of the tire toward the first axial side of the tire, and
wherein the at least one web defines a radial cross-section extending between the inner circumferential barrier and the outer circumferential barrier.

9. The tire of claim 8, wherein the radial cross-section of the at least one web defines a rib portion that is perpendicular to at least one of the inner circumferential barrier and the outer circumferential barrier.

10. The tire of claim 8, wherein the at least one web is located closer to one of the first axial side of the tire and the second axial side of the tire.

11. The tire of claim 8, wherein the at least one web is located adjacent to one of the first axial side of the tire and the second axial side of the tire.

12. The tire of claim 8, wherein the at least one web is located equidistant between the first axial side of the tire and the second axial side of the tire.

13. The tire of claim 8, wherein the cross-section of the at least one web defines a curved third rib portion.

14. A wheel comprising:
a hub configured to be coupled to a machine; and
a non-pneumatic tire coupled to the hub, the tire including:
an inner circumferential barrier configured to be coupled to a hub;
an outer circumferential barrier radially spaced from the inner circumferential barrier; and
a support structure extending between the inner circumferential barrier and the outer circumferential barrier and coupling the inner circumferential barrier to the outer circumferential barrier,
wherein the support structure at least partially defines a first axial side of the tire and a second axial side of the tire opposite the first axial side of the tire, and
wherein the support structure includes:
a plurality of first ribs extending between the inner circumferential barrier and the outer circumferential barrier, and
a plurality of second ribs extending between the inner circumferential barrier and the outer circumferential barrier,
wherein at least some of the plurality of first ribs extend from the first axial side of the tire toward the second axial side of the tire,
wherein at least some of the plurality of second ribs extend from the second axial side of the tire toward the first axial side of the tire, and
wherein the at least some first ribs extend partially from the first axial side of the tire toward the second axial side of the tire, such that the at least some first ribs terminate prior to reaching the second axial side of the tire.

15. The wheel of claim 14, wherein the at least some second ribs extend partially from the second axial side of the tire toward the first axial side of the tire, such that the at least some second ribs terminate prior to reaching the first axial side of the tire.

16. A wheel comprising:
a hub configured to be coupled to a machine; and
a non-pneumatic tire according to claim 7, wherein the inner circumferential barrier of the tire is coupled to the hub.

17. The wheel of claim 16, wherein the support structure at least partially defines a first axial side of the tire and a second axial side of the tire opposite the first axial side of the tire,
wherein at least some of the plurality of first ribs extend from the first axial side of the tire toward the second axial side of the tire,
wherein at least some of the plurality of second ribs extend from the second axial side of the tire toward the first axial side of the tire, and
wherein the at least one web defines a radial cross-section extending between the inner circumferential barrier and the outer circumferential barrier.

18. The wheel of claim 17, wherein the radial cross-section of the at least one web defines a rib portion that is perpendicular to at least one of the inner circumferential barrier and the outer circumferential barrier.

19. A machine configured to travel across terrain, the machine comprising:
at least one wheel, the at least one wheel including:
a hub coupled to the machine; and
a non-pneumatic tire coupled to the hub, wherein the tire includes:
an inner circumferential barrier coupled to the hub;
an outer circumferential barrier radially spaced from the inner circumferential barrier; and
a support structure extending between the inner circumferential barrier and the outer circumferential barrier and coupling the inner circumferential barrier to the outer circumferential barrier,
wherein the support structure at least partially defines a first axial side of the tire and a second axial side of the tire opposite the first axial side of the tire, and
wherein the support structure includes:
a plurality of first ribs extending between the inner circumferential barrier and the outer circumferential barrier, and
a plurality of second ribs extending between the inner circumferential barrier and the outer circumferential barrier,
wherein at least some of the plurality of first ribs extend from the first axial side of the tire toward the second axial side of the tire,
wherein at least some of the plurality of second ribs extend from the second axial side of the tire toward the first axial side of the tire, and
wherein the at least some first ribs extend partially from the first axial side of the tire toward the second axial side of the tire, such that the at least some first ribs terminate prior to reaching the second axial side of the tire.

20. A machine configured to travel across terrain, the machine comprising: at least one wheel, the at least one wheel including:
a hub coupled to the machine; and
a non-pneumatic tire according to claim 7 coupled to the hub.
